(19) United States
(12) Patent Application Publication
(10) Pub. No.: US 2015/0244755 A1
(43) Pub. Date: Aug. 27, 2015

(54) METHOD, APPARATUS, AND HOME NETWORK SYSTEM FOR PRESENTING MULTIPLE IMAGES, AND MOBILE TERMINAL

(71) Applicant: Huawei Device Co., Ltd., Shenzhen (CN)

(72) Inventors: Yunsheng KUANG, Shenzhen (CN); Yu ZHU, Shenzhen (CN)

(21) Appl. No.: 14/682,432

(22) Filed: Apr. 9, 2015

Related U.S. Application Data
(63) Continuation of application No. PCT/CN2013/084866, filed on Oct. 9, 2013.

(30) Foreign Application Priority Data
Oct. 10, 2012 (CN) 201210382232.9

(51) Int. Cl. H04L 29/06; G06F 17/30; H04L 29/08

(52) U.S. Cl. CPC H04L 65/60; H04L 67/10; G06F 17/30876; G06F 17/30268

(57) ABSTRACT

A method for presenting multiple images from a DMS (digital media server), in a same DMR (digital media renderer) includes: sending a first uniform resource identifier URI list setting message to the DMR, so that the DMR acquires, according to the first URI list setting message, multiple images corresponding to multiple URIs from the DMS; and sending a media playback message to the DMR, so that the DMR presents the multiple images together according to the media playback message. According to the method provided in the embodiments of the present invention, multiple images can be shared and presented at the same time between home network media devices, which makes it very convenient to compare the multiple images, thereby helping a user select a best image and make, in a scenario where it is required to perform an illustration on multiple images, a better comparison explanation and illustration on the images.

### CROSS-REFERENCE TO RELATED APPLICATIONS

This application is a continuation of International Patent Application No. PCT/CN2013/084866, filed on Oct. 9, 2013, which claims priority to Chinese Patent Application No. 201210382232.9, filed on Oct. 10, 2012, both of which are hereby incorporated by reference in their entireties.

### TECHNICAL FIELD

The present invention relates to the field of network media, and in particular, to a method, an apparatus, and a home network system for presenting multiple images, and a mobile terminal.

### BACKGROUND

With rapid development of home network media technologies, more and more digital media devices appear in an ordinary family, and many traditional home media devices, such as a television and an acoustic system, also have a network access function. These home media devices are connected in a wired or wireless manner to form a home network (the home media devices may be referred to as “home network media devices”), so as to implement functions such as content sharing and mutual control.

To implement media content sharing between the home network media devices, the UPnP Forum (Universal Plug and Play Forum) formulates the UPnP AV (Universal Plug and Play Audio Video) standard. The UPnP AV standard defines three types of logical devices in the home network, including: a media server (MS), a media player (MP) and a control point (CP), where the MS provides an audio video (AV) media resource, the MP is used to play media content from the media server, and the CP reads device information of the MS and the MP by invoking a related control action (action), so as to implement control of media transfer and playback. The Digital Living Network Alliance (DLNA) cites the UPnP AV standard and defines device classes, such as a digital media server (DMS), a digital media renderer (DMR), and a digital media player (DMP).

In an existing DLNA media transfer and playback standard architecture, a series of control actions (action) are invoked by the CP to implement image file transfer and presentation on the home network, specifically including step S1 to step S6:

S1. The CP invokes a CDS::Browse( )/Search( ) action to the DMS to acquire a media playlist of the DMS.

S2. The CP separately invokes a CMS::GetProtocolInfo( ) action to the DMS and the DMR to acquire a protocol supported by the DMS and DMR, and performs matching.

S3. The CP invokes an AVT::SetAVTransportURI( ) action to the DMR, and the DMR obtains a uniform resource identifier (URI) of a to-be-played picture file.

S4. The control point CP invokes an AVT::Play( ) action to the DMR to instruct the DMR to play the picture file.

S5. The DMR sends an HTTP GET request action to the DMS according to the URI of the to-be-played picture file to request data of the to-be-played picture file.

S6. The DMS delivers the data of the to-be-played picture file in an HTTP GET response message to the DMR, where the picture is presented in the DMR.

The inventor finds that the method, which is defined in the DLNA media transfer and playback standard architecture, for transferring and presenting an image file in a home network is essentially to trigger a transfer and playback operation by using the AVT::SetAVTransportURI( ) action, and a feature of the method is that each operation can be performed for only one URI. Therefore, only one image can be presented at a time in a same DMR, and multiple images cannot be simultaneously presented in a same DMR. If the AVT:: SetAVTransportURI( ) action is invoked for multiple times, with an expectation to present multiple images in the DMR, an image corresponding to a previous URI is edged out by an image corresponding to a next URI, and still only one image can be presented.

### SUMMARY

Embodiments of the present invention provide a method, an apparatus, and a home network system for presenting multiple images, and a mobile terminal, so as to present together the multiple images from a digital media server in a same digital media renderer.

An embodiment of the present invention provides a method for presenting multiple images, where the method includes: sending a first uniform resource identifier URI list setting message to a digital media renderer, where the first uniform resource identifier URI list setting message includes a list of multiple uniform resource identifiers respectively corresponding to the multiple images, so that the digital media renderer acquires, according to the first URI list setting message, the multiple images corresponding to the multiple URIs from a digital media server; and sending a media playback message to the digital media renderer, so that the digital media renderer presents the multiple images together according to the media playback message.

An embodiment of the present invention provides a method for presenting multiple images, where the method includes: receiving a first uniform resource identifier URI list setting message and a media playback message that are sent by a digital media controller, where the first uniform resource identifier URI list setting message includes a list of multiple uniform resource identifiers respectively corresponding to the multiple images; acquiring, according to the first uniform resource identifier URI list setting message, the multiple images corresponding to the multiple uniform resource identifiers from a digital media server; and presenting together, according to the media playback message, the multiple images corresponding to the multiple uniform resource identifiers.

An embodiment of the present invention provides a method for presenting multiple images, where the method includes: sending a first uniform resource identifier URI setting message to a digital media renderer, where the first uniform resource identifier URI setting message includes a first uniform resource identifier corresponding to a first image; sending a media playback message to the digital media renderer, so that the digital media renderer acquires, according to the uniform resource identifier URI setting message, the first image corresponding to the first uniform resource identifier from a digital media server, and presents the first image according to the media playback message; and sending an adding message to the digital media renderer, where the adding message includes a uniform resource identifier corresponding to a second image, so that the digital media renderer acquires the second image from the digital media server according to the adding message, and presents the first image and the second image together.

An embodiment of the present invention provides a method for presenting multiple images, where the method includes: receiving a first uniform resource identifier URI setting message and a media playback message that are sent by a digital media controller, where the first URI setting message includes a first URI corresponding to a first image; acquiring, according to the first URI setting message, the first image corresponding to the first URI from a digital media server; presenting, according to the media playback message, the first image corresponding to the first URI; receiving an adding message sent by the digital media controller, where the adding message includes a second URI corresponding to a second image; and acquiring the second image from the digital media server according to the adding message, and presenting the first image and the second image together.

An embodiment of the present invention provides an apparatus for presenting multiple images, where the apparatus includes: a first sending module, configured to send a first uniform resource identifier URI list setting message to a digital media renderer, where the first uniform resource identifier URI list setting message includes a list of multiple uniform resource identifiers respectively corresponding to the multiple images, so that the digital media renderer acquires, according to the first URI list setting message, the multiple images corresponding to the multiple uniform resource identifiers from a digital media server; and a second sending module, configured to send a media playback message to the digital media renderer, so that the digital media renderer presents the multiple images together according to the media playback message.

An embodiment of the present invention provides an apparatus for presenting multiple images, where the apparatus includes: a receiving module, configured to receive a first uniform resource identifier URI list setting message and a media playback message that are sent by a digital media controller, where the first uniform resource identifier URI list setting message includes a list of multiple uniform resource identifiers respectively corresponding to the multiple images; an acquiring module, configured to acquire, according to the first uniform resource identifier URI list setting message and the media playback message, the multiple images corresponding to the multiple uniform resource identifiers from a digital media server; and a presenting module, configured to present together the multiple images corresponding to the multiple uniform resource identifiers.

An embodiment of the present invention provides an apparatus for presenting multiple images, where the apparatus includes: a first sending module, configured to send a first uniform resource identifier URI setting message to a digital media renderer, where the first uniform resource identifier URI setting message includes a first uniform resource identifier corresponding to a first image; a second sending module, configured to send a media playback message to the digital media renderer, so that the digital media renderer acquires, according to the uniform resource identifier URI setting message, the first image corresponding to the first uniform resource identifier from a digital media server, and presents the first image according to the media playback message; and a third sending module, configured to send an adding message to the digital media renderer, where the adding message includes a second uniform resource identifier corresponding to a second image, so that the digital media renderer acquires, according to the adding message, the second image corresponding to the second uniform resource identifier from the digital media server, and presents the first image and the second image together.

An embodiment of the present invention provides an apparatus for presenting multiple images, where the apparatus includes: a first receiving module, configured to receive a first uniform resource identifier URI setting message and a media playback message that are sent by a digital media controller, where the first uniform resource identifier URI setting message includes a first uniform resource identifier corresponding to a first image; a first acquiring module, configured to acquire, according to the first uniform resource identifier URI setting message and the media playback message, the first image corresponding to the first uniform resource identifier from a digital media server; a presenting module, configured to present the first image corresponding to the first uniform resource identifier; a second receiving module, configured to receive an adding message sent by the digital media controller, where the adding message includes a second uniform resource identifier corresponding to a second image; a second acquiring module, configured to acquire, according to the adding message, the second image corresponding to the second uniform resource identifier from the digital media server; and the presenting module, further configured to present the first image and the second image together.

An embodiment of the present invention provides a home network system for presenting multiple images, where the home network system includes: a digital media server, a digital media controller, and a digital media renderer, where the digital media server is configured to transfer the multiple images to the digital media renderer under control of the digital media controller; the digital media controller is configured to send a first uniform resource identifier URI list setting message and send a media playback message to the digital media renderer, so that the digital media renderer acquires, according to the first uniform resource identifier URI list setting message, multiple images corresponding to multiple uniform resource identifiers from the digital media server, and presents the multiple images together according to the media playback message, where the first uniform resource identifier URI list setting message includes a list of the multiple uniform resource identifiers respectively corresponding to the multiple images; and the digital media renderer is configured to: receive the first uniform resource identifier URI list setting message and the media playback message that are sent by the digital media controller; acquire, according to the first uniform resource identifier URI list setting message, the multiple images corresponding to the multiple uniform resource identifiers from the digital media server; and present together, according to the media playback message, the multiple images corresponding to the multiple uniform resource identifiers.

An embodiment of the present invention provides a mobile terminal, where the mobile terminal includes: a digital media source, a control module, and a display module, where the digital media source is configured to transfer multiple images to the display module under control of the control module; the control module is configured to send a first uniform resource identifier URI list setting message and send a media playback message to the display module, so that the display module acquires, according to the first uniform resource identifier URI list setting message, multiple images corresponding to multiple uniform resource identifiers from the digital media source, and presents the multiple images together, where the first uniform resource identifier URI list setting message includes a list of the multiple uniform resource identifiers respectively corresponding to the multiple images; and the display module is configured to: receive the first uniform resource identifier URI list setting message sent by the control module; acquire, according to the first uniform resource identifier URI list setting message, the multiple images corresponding to the multiple uniform resource identifiers from the digital media source; and present the multiple images together according to the media playback message.

An embodiment of the present invention provides a home network system for presenting multiple images, where the home network system includes: a digital media server, a digital media controller, and a digital media renderer, where the digital media server is configured to transfer the multiple images to the digital media renderer under control of the digital media controller; the digital media controller is configured to: send a first uniform resource identifier URI setting message to the digital media renderer, where the first uniform resource identifier URI setting message includes a first uniform resource identifier corresponding to a first image; send a media playback message to the digital media renderer, so that the digital media renderer acquires, according to the uniform resource identifier URI setting message, the first image corresponding to the first uniform resource identifier from the digital media server, and presents the first image according to the media playback message; and send an adding message to the digital media renderer, where the adding message includes a uniform resource identifier corresponding to a second image, so that the digital media renderer acquires the second image from the digital media server according to the adding message, and presents the first image and the second image together; and the digital media renderer is configured to: receive the first uniform resource identifier URI setting message and the media playback message that are sent by the digital media controller, where the first URI setting message includes the first URI corresponding to the first image; acquire, according to the first URI setting message, the first image corresponding to the first URI from the digital media server; present, according to the media playback message, the first image corresponding to the first URI; receive an adding message sent by the digital media controller, where the adding message includes a second URI corresponding to a second image; acquire the second image from the digital media server according to the adding message; and present the first image and the second image together.

It can be learned from the foregoing embodiments of the present invention, because the first uniform resource identifier URI list setting message that is sent by the digital media controller to the digital media renderer includes the list of the multiple uniform resource identifiers respectively corresponding to the multiple images, after the digital media renderer acquires the multiple images corresponding to the multiple uniform resource identifiers from the digital media server, the multiple images can be presented together. Therefore, compared with a method, provided in the prior art, for transferring and presenting an image file in a home network, in the method provided in the embodiments of the present invention, the multiple images can be shared and presented at the same time between home network media devices, which makes it very convenient to compare the multiple images, thereby helping a user select a best image and make, in a scenario where it is required to perform an illustration on multiple images, a better comparison explanation and illustration on the images.

### BRIEF DESCRIPTION OF DRAWINGS

To describe the technical solutions in the embodiments of the present invention more clearly, the following briefly introduces the accompanying drawings required for describing or the embodiments. Apparently, the accompanying drawings in the following description show merely some embodiments of the present invention, and a person skilled in the art may still derive other drawings from these accompanying drawings.

FIG. 1 is a schematic flowchart of a method for presenting multiple images according to an embodiment of the present invention;

FIG. 2 is a schematic flowchart of interaction between devices in a home network or a home network subnet formed by a DMC, a DMS, and a DMR according to an embodiment of the present invention;

FIG. 3-a is a schematic diagram of presenting multiple images according to an embodiment of the present invention;

FIG. 3-b is a schematic diagram of presenting the multiple images shown in FIG. 3-a after positions of the multiple images are changed according to an embodiment of the present invention;

FIG. 4-a is a schematic diagram of presenting multiple images according to another embodiment of the present invention;

FIG. 4-b is a schematic diagram of presenting multiple images after an image is added to the multiple images shown in FIG. 4-a according to an embodiment of the present invention;

FIG. 5-a is a schematic diagram of presenting multiple images according to another embodiment of the present invention;

FIG. 5-b is a schematic diagram of presenting multiple images after an image is deleted from the multiple images shown in FIG. 5-a according to an embodiment of the present invention;

FIG. 6-a is a schematic diagram of presenting multiple images according to another embodiment of the present invention;

FIG. 6-b is a schematic diagram of presenting multiple images after an image of the multiple images shown in FIG. 6-a is substituted according to an embodiment of the present invention;

FIG. 7 is a schematic flowchart of a method for presenting multiple images according to another embodiment of the present invention;

FIG. 8-a is a schematic flowchart of a method for setting and adjusting a display size and position of an image according to an embodiment of the present invention;

FIG. 8-b is a schematic flowchart of a method for presenting multiple images according to another embodiment of the present invention;

FIG. 8-c is a schematic flowchart of a method for presenting multiple images according to another embodiment of the present invention;

FIG. 9 is a schematic structural diagram of an apparatus for presenting multiple images according to an embodiment of the present invention;

FIG. 10 is a schematic structural diagram of an apparatus for presenting multiple images according to another embodiment of the present invention;

FIG. 11 is a schematic structural diagram of an apparatus for presenting multiple images according to another embodiment of the present invention;

FIG. 12 is a schematic structural diagram of an apparatus for presenting multiple images according to another embodiment of the present invention;

FIG. 13 is a schematic structural diagram of an apparatus for presenting multiple images according to another embodiment of the present invention;

FIG. 14 is a schematic structural diagram of an apparatus for presenting multiple images according to another embodiment of the present invention;

FIG. 15 is a schematic structural diagram of an apparatus for presenting multiple images according to another embodiment of the present invention;

FIG. 16 is a schematic structural diagram of an apparatus for presenting multiple images according to another embodiment of the present invention;

FIG. 17 is a schematic structural diagram of an apparatus for presenting multiple images according to another embodiment of the present invention;

FIG. 18 is a schematic structural diagram of an apparatus for presenting multiple images according to another embodiment of the present invention;

FIG. 19 is a schematic structural diagram of an apparatus for presenting multiple images according to another embodiment of the present invention;

FIG. 20 is a schematic structural diagram of an apparatus for presenting multiple images according to another embodiment of the present invention;

FIG. 21 is a schematic structural diagram of an apparatus for presenting multiple images according to another embodiment of the present invention;

FIG. 22-a is a schematic structural diagram of an apparatus for presenting multiple images according to another embodiment of the present invention;

FIG. 22-b is a schematic structural diagram of an apparatus for presenting multiple images according to another embodiment of the present invention;

FIG. 22-c is a schematic structural diagram of an apparatus for presenting multiple images according to another embodiment of the present invention;

FIG. 22-d is a schematic structural diagram of an apparatus for presenting multiple images according to another embodiment of the present invention;

FIG. 22-e is a schematic structural diagram of an apparatus for presenting multiple images according to another embodiment of the present invention;

FIG. 22-f is a schematic structural diagram of an apparatus for presenting multiple images according to another embodiment of the present invention;

FIG. 23 is a schematic structural diagram of an apparatus for presenting multiple images according to another embodiment of the present invention;

FIG. 24 is a schematic structural diagram of a home network system for presenting multiple images according to an embodiment of the present invention;

FIG. 25 is a schematic structural diagram of an apparatus for presenting multiple images according to another embodiment of the present invention;

FIG. 26 is a schematic structural diagram of an apparatus for presenting multiple images according to another embodiment of the present invention;

FIG. 27 is a schematic structural diagram of an apparatus for presenting multiple images according to another embodiment of the present invention; and

FIG. 28 is a schematic structural diagram of a home network system for presenting multiple images according to another embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person skilled in the art based on the embodiments of the present invention shall fall within the protection scope of the present invention.

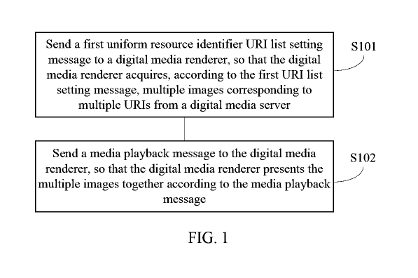

Referring to FIG. 1, FIG. 1 is a schematic flowchart of a method for presenting multiple images according to an embodiment of the present invention, and an execution body of the method may be a digital media controller (DMC) in a home network provided in this embodiment of the present invention. The method shown in FIG. 1 mainly includes step S101 and step S102.

S101. Send a first uniform resource identifier URI list setting message to a digital media renderer, so that the digital media renderer acquires, according to the first URI list setting message, multiple images corresponding to multiple URIs from a digital media server.

In this embodiment of the present invention, the sending, by the DMC, a first uniform resource identifier (URI) list setting message to a digital media renderer (DMR) may be implemented by invoking an AVT::SetAVTransportURIList( ) action to the digital media renderer, that is, the AVT::SetAVTransportURIList( ) action is invoked to the digital media renderer to implement the sending of the first URI list setting message to the DMR and receiving of a response of the first uniform resource identifier URI list setting message. In addition to a list of the multiple URIs respectively corresponding to the multiple images, the first URI list setting message may also include a list of multiple pieces of image file metadata information that respectively correspond to the multiple uniform resource identifiers in a one-to-one manner, where an image, a URI, and a piece of image file metadata information are in a one-to-one relationship, that is, the number of images corresponds to the number of URIs and the number of pieces of image file metadata information.

S102. Send a media playback message to the digital media renderer, so that the digital media renderer presents the multiple images together according to the media playback message.

In this embodiment of the present invention, the sending, by the DMC, a media playback message to the digital media renderer may be implemented by invoking an AVT::Play( ) action to the digital media renderer, that is, the AVT::Play( ) action is invoked to the digital media renderer to implement the sending of the media playback message to the DMR and receiving of a response of the media playback message. The AVT::Play( ) action is used to command the digital media renderer to acquire a media resource from the digital media server (DMS), such as an image or a picture.

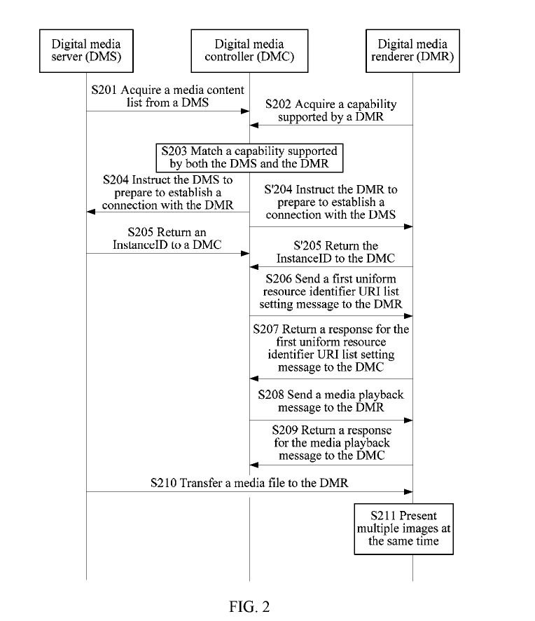

As preparation work, in this embodiment of the present invention, the method for presenting the multiple images further includes: before the sending a first uniform resource identifier URI list setting message to a digital media renderer, establishing, by the DMC, a connection between the DMS and the DMR; and after the sending a media playback message to the DMR, acquiring, by the DMR, the multiple images corresponding to the multiple URIs and presenting the multiple images at the same time. For a specific embodiment, refer to FIG. 2. An interaction procedure, provided in this embodiment of the present invention, between devices in a home network or a home network subnet formed by the DMC, DMS and DMR is described as follows:

S201. The DMC acquires a media content list from the DMS.

In this embodiment of the present invention, the DMC invokes a CDS::Browse( ) action to the DMS to browse a media content list or invokes a CDS::Search( ) action to search for matched media content, so as to acquire the media content list from the DMS.

S202. The DMC acquires a capability supported by the DMR.

In this embodiment of the present invention, the DMC invokes a CMS::GetProtocolInfo( ) action to the DMR to acquire the capability supported by the DMR, that is, a media transfer protocol and a media encoding format that are supported by the DMR.

S203. The DMC matches a capability supported by both the DMS and the DMR.

That is, the DMC chooses a matched transfer protocol and media format according to the media content list acquired from the DMS and the media transfer protocol and the media encoding format that are supported by the DMR. For example, an H.264 format media file is stored in the DMS, and by invoking the CMS::GetProtocolInfo( ) action, the DMC learns that the DMR supports playback of the H.264 format media file, then the DMC chooses the matched media format, that is, the H.264 format for the DMR and the DMS.

S204. The DMC instructs the DMS to prepare to establish the connection with the DMR.

S′204. The DMC instructs the DMR to prepare to establish the connection with the DMS.

The preparing, by the DMS, to establish the connection with the DMR may be implemented by separately invoking a CMS::PrepareForConnection( ) action to the DMS and the DMR, and a media transfer protocol and an encoding format that are to be used are provided for the DMS and the DMR.

S205. The DMS returns an InstanceID to the DMC.

S′205. The DMR returns the InstanceID to the DMC.

That is, the DMS and the DMR separately returns the InstanceID that identifies to-be-started media transfer to the DMC, and subsequently, the DMC may control media playback by using this InstanceID.

S206. The DMC sends the first uniform resource identifier URI list setting message to the DMR.

As described above, the sending, by the DMC, the first uniform resource identifier URI list setting message to the DMR is implemented by invoking the AVT::SetAVTransportURI List( ) action to the DMR. In this embodiment of the present invention, the AVT::SetAVTransportURIList( ) action includes three variables, that is, the InstanceID, a CurrentURIList, and CurrentURIListMetaData, as shown in the following Table 1.

TABLE 1
A variable list included in the
AVT::SetAVTransportURIList( ) action

| Variable | Direction | State variable |
|---|---|---|
| InstanceID | IN | A_ARG_TYPE_InstanceID |
| CurrentURIList | IN | AVTransportURIList |
| CurrentURIListMetaData | IN | AVTransportURIListMetaData |

An extensible markup language (XML) of service description of a device that carries the AVT::SetAVTransportURIList( ) action is as follows:

<?xml version=“1.0” encoding=“UTF-8”?>
<scpd xmlns=“urn:schemas-upnp-org:service-1-0”>
<specVersion>
<major>1</major>
<minor>0</minor>
</specVersion>
<actionList>
<action>
<name>SetAVTransportURIList</name>
<argumentList>
<argument>
<name>InstanceID</name>
<direction>in</direction>
<relatedStateVariable>A_ARG_TYPE_InstanceID</relatedStateVariable>
</argument>
<argument>
<name>CurrentURIList</name>
<direction>in</direction>
<relatedStateVariable>AVTransportURIList</relatedStateVariable>
</argument>
<argument>
<name>CurrentURIListMetaData</name>
<direction>in</direction>
<relatedStateVariable>AVTransportURIListMetaData</relatedStateVariable>
</argument>
</argumentList>
</action>
......
</actionList>
<serviceStateTable>
<stateVariable sendEvents=“no”>
<name>A_ARG_TYPE_InstanceID</name>
<dataType>ui4</dataType>
</stateVariable>
<stateVariable sendEvents=“no”>
<name>AVTransportURIList</name>
<dataType>string</dataType>
</stateVariable>
<stateVariable sendEvents=“no”>
<name>AVTransportURIListMetaData</name>

Bold parts in the foregoing XML description example are the variables shown in Table 1, where the variable InstanceID is an identifier value returned by the DMS and the DMR when the DMC invokes the CMS::PrepareForConnection( ) action to the DMS and the DMR in step S204, and the identifier value is set to 0 by default; the variable CurrentURIList indicates a URI list of multiple images to be transferred and presented; and the variable CurrentURIListMetaData indicates a list of image file metadata information corresponding to a URI in the URI list, where the list of image file metadata information includes a uniform resource locator (URL), image size information, image resolution information, and the like of an image file, and each piece of image file metadata information in the list of the image file metadata information sequentially corresponds to each URI in the variable CurrentURIList in a one-to-one manner. To more clearly understand the foregoing variables in the AVT::SetAVTransportURIList( ) action, an example of a request packet of invoking the AVT::SetAVTransportURIList( ) action is provided as follows:

<?xml version=“1.0”encoding=“utf-8”?>
<s:Envelope
s:encodingStyle=http://schemas.xmlsoap.org/soap/encoding/
xmlns:s=“http://schemas.xmlsoap.org/soap/envelope”>
<s:Body>
<u:SetAVTransportURIList

xmlns:u=“urn:schemas-upnp-org:service:AVTransport:1”>

<InstanceId>0</InstanceId>
<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>
<CurrentURIListMetaData>
<CurrentURIMetaData>
&lt;DIDL-Lite
xmlns=“urn:schemas-upnp-org:metadata-1-0/DIDL-Lite”
xmlns:dc=http://purl.org/dc/elements/1.1/
xmlns:upnp=“urn:schemas-upnp-org:metadata-1-0/upnp”&gt;
&lt;res protocolInfo=“http-get:*:image/jpg;DLNA.ORG_OP=01”
length=“800”
width=“480”
resolution=“400×224”&gt;
http://10.11.85.185/53235/image1.jpg&lt;/res&gt;
&lt;/DIDL-Lite&gt;
</CurrentURIMetaData>
<CurrentURIMetaData>
&lt;DIDL-Lite
xmlns=“urn:schemas-upnp-org:metadata-1-0/DIDL-Lite”
xmlns:dc=http://purl.org/dc/elements/1.1/
xmlns:upnp=“urn:schemas-upnp-org:metadata-1-0/upnp”&gt;
&lt;res protocollnfo=“http-get:*:image/jpg;DLNA.ORG_OP=01”
length=“800”
width=“480”
resolution=“400×224”&gt;
http://10.11.85.185/53235/image2.jpg&lt;/res&gt;
&lt;/DIDL-Lite&gt;
</CurrentURIMetaData>
<CurrentURIMetaData>
&lt;DIDL-Lite
xmlns=“urn:schemas-upnp-org:metadata-1-0/DIDL-Lite”
xmlns:dc=http://purl.org/dc/elements/1.1/
xmlns:upnp=“urn:schemas-upnp-org:metadata-1-0/upnp”&gt;
&lt;res protocolInfo=“http-get:*:image/jpg;DLNA.ORG_OP=01”
length=“960”
width=“540”
resolution=“800×600”&gt;
http://10.11.85.185/53235/image3.jpg&lt;/res&gt;
&lt;/DIDL-Lite&gt;
</CurrentURIMetaData>
</CurrentURIListMetaData>
</SetAVTransportURIList>
</s:Body>
</s:Envelope>

In the foregoing example of the request packet, a bold non-italic part is the URI in the variable CurrentURIList, and a bold italic part is the image file metadata information that is indicated by the variable CurrentURIListMetaData and corresponds to the URI in the URI list.

S207′. The DMR returns a response of the first uniform resource identifier URI list setting message to the DMC.

S208. The DMC sends the media playback message to the DMR.

As described above, the sending, by the DMC, the media playback message to the DMR is implemented by invoking the AVT::Play( ) action to the DMR.

S209. The DMR returns a response of the media playback message to the DMC.

S210. The DMS transfers a media file to the DMR.

After the DMR acquires the to-be-presented media file, that is, the URI list of the multiple images, the DMS compresses and packs the multiple to-be-presented images into a file, and transfers the file to the DMR by using an HTTP protocol.

S211. The DMR presents the multiple images at the same time.

After receiving a compressed package of the image file, the DMR obtains, by decompressing, the multiple to-be-presented images. Specifically, after the DMR receives data of the to-be-presented image file delivered by the DMS, the DMR sets and adjusts an image display size and a display position in a screen according to information (refer to the bold italic part in request packet in the foregoing example), such as an image size and a resolution in the variable CurrentURIListMetaData in the AVT::SetAVTransportURIList( ) that is invoked by the DMC to the DMR.

It can be learned from the foregoing method for presenting the multiple images according to this embodiment of the present invention, because the first uniform resource identifier URI list setting message sent by the digital media controller to the digital media renderer includes the list of the multiple URIs respectively corresponding to the multiple images, and after acquiring the multiple images corresponding to the multiple URIs from the digital media server, the digital media renderer may present the multiple images together. Therefore, compared with inter-frame prediction encoding motion information processing provided in the prior art, in the method provided in this embodiment of the present invention, the multiple images may be shared and presented at the same time between home network media devices, so that performing a comparison on the multiple images becomes very convenient, thereby helping a user select a best image, and in a scenario where it is required to perform an illustration on multiple images, helping a user perform a better comparison explanation and illustration on the images.

In an actual application scenario of the multiple images, performing deletion, transposition, substitution, and the like on the multiple images presented in the screen are operations that are often performed by the user, and actually, these operations are also presenting manner changes performed on the presented images. As an embodiment of the present invention, after the digital media controller sends the media playback message to the digital media renderer, a presenting manner change message may also be sent to the digital media renderer, so that the digital media renderer changes a presenting manner of the multiple images in the digital media renderer.

As an embodiment in which the presenting manner change message is sent to the digital media renderer, a second uniform resource identifier URI list setting message that includes multiple URIs listed according to a sequence may be sent to the digital media renderer, so that the digital media renderer arranges and displays, according to the sequence, multiple images corresponding to the multiple URIs listed according to the sequence. For example, according to the foregoing example of the request packet of invoking the AVT::SetAVTransportURIList( ) action, a sequence of the listed URIs in the CurrentURIList is as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

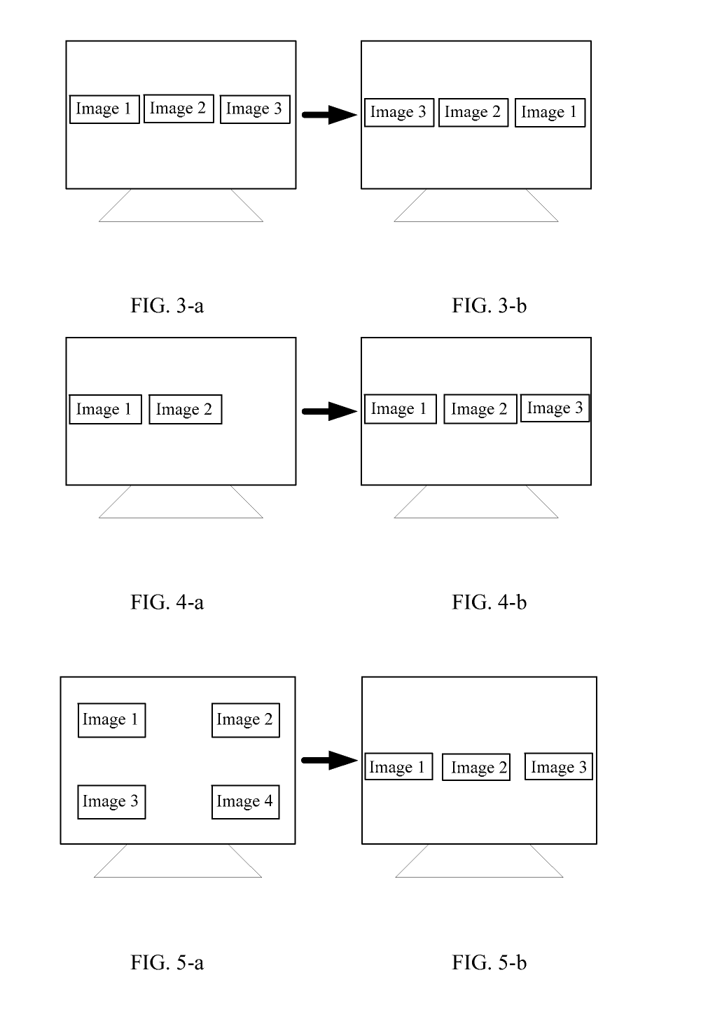

According to the foregoing URI listing sequence, when image 1 (that is, image1.jpg), image 2 (that is, image2.jpg), and image 3 (that is, image3.jpg) are displayed in the DMR, image 1, image 2, and image 3 are sequentially arranged in a left-to-right sequence, as shown in FIG. 3-a.

To meet a requirement, now it is required to change the arrangement sequence of the three images. For example, image 3, image 2, and image 1 are required to be sequentially displayed in the DMR in a left-to-right sequence. In this case, the DMC may invoke the AVT::SetAVTransportURIList( ) action to the DMR to implement the sending, to the DMR, of the second uniform resource identifier URI list setting message that includes multiple URIs listed according to a sequence, and a sequence of the URIs listed in the CurrentURIList in the request packet of the AVT::SetAVTransportURIList( ) action is as follows:

<CurrentURIList>
<CurrentURI>http://10.11.85.185/53235/image3.jpg</CurrentURI>
<CurrentURI>http://10.11.85.185/53235/image2.jpg</CurrentURI>
<CurrentURI>http://10.11.85.185/53235/image1.jpg</CurrentURI>
</CurrentURIList>

According to the foregoing URI listing sequence, when image 1 (that is, image1.jpg), image 2 (that is, image2.jpg), and image 3 (that is, image3.jpg) are displayed in the DMR, image 3, image 2, and image 1 are sequentially arranged in a left-to-right sequence, as shown in FIG. 3-b.

As another embodiment in which the presenting manner change message is sent to the digital media renderer, a third uniform resource identifier URI list setting message that includes a URI corresponding to a newly-added image may be sent to the digital media renderer, so that the digital media renderer presents original images and the newly-added image at the same time. For example, it is assumed that when the DMC previously invokes the AVT::SetAVTransportURIList( ) action to the DMR, an objective is to present only two images together in the DMR, such as image 1 (that is, image1.jpg) and image 2 (that is, image2.jpg), as shown in FIG. 4-a. That is, the variable CurrentURIList in the AVT::SetAVTransportURIList( ) action is described as follows:

<CurrentURIList>
<CurrentURI>http://10.11.85.185/53235/image1.jpg</CurrentURI>
<CurrentURI>http://10.11.85.185/53235/image2.jpg</CurrentURI>
</CurrentURIList>

Now it is required to add one image to the DMR, such as image 3 (that is, image3.jpg). Then the DMC may invoke the AVT::SetAVTransportURIList( ) action to the DMR to implement the sending, to the DMR, of the third uniform resource identifier URI list setting message that includes the URI corresponding to the newly-added image, where the variable CurrentURIList in the AVT::SetAVTransportURIList( ) action (it is assumed that image 1, image 2, and image 3 are displayed in the DMR in a left-to-right sequence) is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

It can be learned from a comparison that, a URI of the newly-added image 3 (image3.jpg) is added to the variable CurrentURIList, and image 1 (that is, image1.jpg), image 2 (that is, image2.jpg), and image 3 (that is, image3.jpg) are presented together in the DMR, as shown in FIG. 4-b.

As another embodiment in which the presenting manner change message is sent to the digital media renderer, a fourth uniform resource identifier URI list setting message that includes a URI corresponding to an image that is reserved to be presented may be sent to the digital media renderer, so that the digital media renderer presents, at the same time, only the image that is reserved to be presented. For example, it is assumed that when the DMC previously invokes the AVT::SetAVTransportURIList( ) action to the DMR, an operation result is that four images are presented at the same time in the DMR, such as image 1 (that is, image1.jpg), image 2 (that is, image2.jpg), image 3 (that is, image3.jpg), and image 4 (that is, image4.jpg), as shown in FIG. 5-a. That is, the variable CurrentURIList in the AVT::SetAVTransportURIList( ) action is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
<CurrentURI>http://10.11.85.185/53235/image4.jpg</CurrentURI>
</CurrentURIList>

Now it is required to delete one image. For example, it is required to delete image 4 (that is, image4.jpg). In this case, the DMC may invoke the AVT::SetAVTransportURIList( ) action to the DMR to implement the sending, to the DMR, of the fourth uniform resource identifier URI list setting message that includes the URI corresponding to the image that is reserved to be presented, where the variable CurrentURIList in the AVT::SetAVTransportURIList( ) action (it is assumed that image 1, image 2, and image 3 are displayed in the DMR in a left-to-right sequence) is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

It can be learned from a comparison that, a URI of the deleted image 4 (image4.jpg) is removed from the variable CurrentURIList, and only image 1 (that is, image1.jpg), image 2 (that is, image2.jpg), and image 3 (that is, image3.jpg) are presented at the same time in the DMR, as shown in FIG. 5-b.

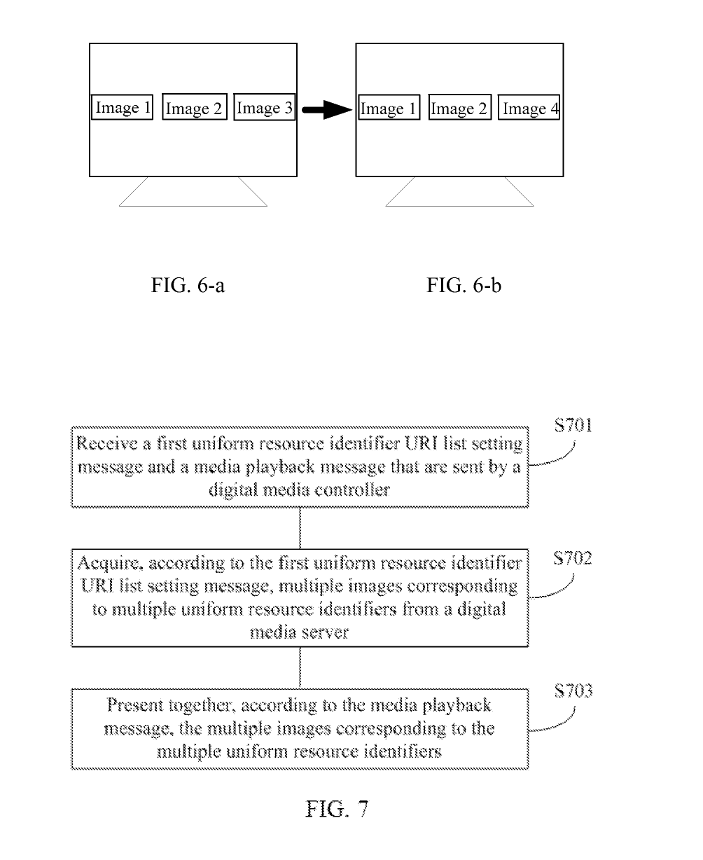

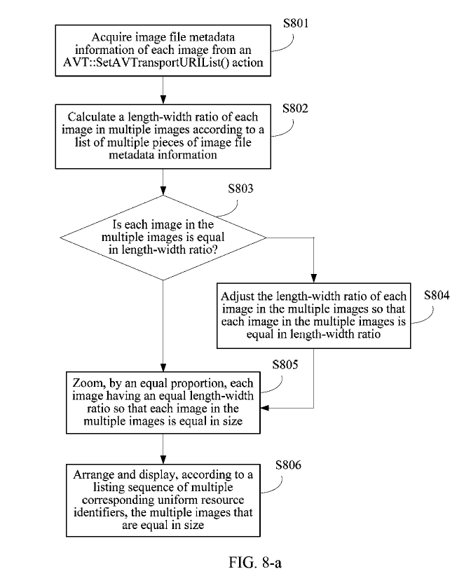

As another embodiment in which the presenting manner change message is sent to the digital media renderer, a fifth uniform resource identifier URI list setting message that includes a URI corresponding to a substituting image may be sent to the digital media renderer, so that the digital media renderer presents a non-substituted image and the substituting image at the same time. For example, it is assumed that when the DMC previously invokes the AVT::SetAVTransportURIList( ) action to the DMR, an operation result is that three images are presented together in the DMR, such as image 1 (that is, image1.jpg), image 2 (that is, image2.jpg), and image 3 (that is, image3.jpg), as shown in FIG. 6-a. That is, the variable CurrentURIList in the AVT::SetAVTransportURIList( ) action is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

Now it is required to substitute one of the images. For example, image 3 (that is, image3.jpg) is substituted by image 4 (that is, image4.jpg). In this case, the DMC may invoke the AVT::SetAVTransportURIList( ) action to the DMR to implement the sending, to the DMR, of the fifth uniform resource identifier URI list setting message that includes the URI corresponding to the substituting image, where the variable CurrentURIList in the AVT::SetAVTransportURIList( ) action (it is assumed that image 1, image 2, and image 4 are displayed in the DMR in a left-to-right sequence) is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image4.jpg</CurrentURI>
</CurrentURIList>

It can be learned from a comparison that, in the variable CurrentURIList, a URI of the deleted image 3 (image3.jpg) is substituted by a URI of image 4 (image4.jpg), and image 1 (that is, image1 jpg), image 2 (that is, image2.jpg), and the substituted image 4 (that is, image4.jpg) are presented together in the DMR, as shown in FIG. 6-b.

Reference is made to FIG. 7, which is a schematic flowchart of a method for presenting multiple images according to another embodiment of the present invention, and an execution body of the method may be a digital media renderer (DMR) in a home network provided in this embodiment of the present invention. The method shown in FIG. 7 mainly includes step S701, step S702, and step S703, where the method is described in detail as follows:

S701. Receive a first uniform resource identifier URI list setting message and a media playback message that are sent by a digital media controller.

In this embodiment, sending the first uniform resource identifier URI list setting message by the DMC is implemented by invoking an AVT::SetAVTransportURIList( ) action by the DMC to the DMR, that is, the AVT::SetAVTransportURIList( ) action is invoked to the DMR to implement the sending of the first uniform resource identifier URI list setting message to the DMR. The DMR receives the first uniform resource identifier URI list setting message and returns a response of the first uniform resource identifier URI list setting message to the DMC. In addition to a list of multiple URIs that respectively correspond to the multiple images in a one-to-one manner, the first uniform resource identifier URI list setting message may also include a list of multiple pieces of image file metadata information respectively corresponding to the multiple URIs, where an image, a URI, and a piece of image file metadata information are in a one-to-one relationship, that is, the number of multiple images corresponds to the number of URIs and the number of pieces of image file metadata information.

Before the first uniform resource identifier URI list setting message sent by the DMC is received, the DMC acquires a media content list from the DMS and acquires a capability supported by the DMR, the DMC matches a capability supported by both the DMS and the DMR, the DMC establishes a connection between the DMS and the DMR, and the like. For details, refer to FIG. 2.

In this embodiment, sending the media playback message by the DMC is implemented by invoking an AVT::Play( ) action by the DMC to the DMR, that is, the AVT::Play( ) action is invoked to the DMR to implement the sending of the media playback message to the DMR. The DMR receives the media playback message and returns a response of the media playback message to the DMC. The AVT::Play( ) action is used to command the digital media renderer to acquire a media resource from the DMS, such as an image or a picture.

S702. Acquire, according to the first uniform resource identifier URI list setting message, the multiple images corresponding to the multiple URIs from a digital media server.

The AVT::SetAVTransportURIList( ) action that is invoked when implementing the sending of the first uniform resource identifier URI list setting message includes three variables, that is, an InstanceID, a CurrentURIList, and CurrentURIListMetaData, where the variable InstanceID is an identifier value returned by the DMS and the DMR when the DMC invokes a CMS::PrepareForConnection( ) action to the DMS and the DMR in step S204 shown in FIG. 2, and the identifier value is set to 0 by default; the variable CurrentURIList indicates a URI list of multiple images to be transferred and presented; and the variable CurrentURIListMetaData indicates a list of image file metadata information corresponding to a URI in the URI list, where the list of image file metadata information includes a URL, image size information, image resolution information, and the like of an image file, and each piece of image file metadata information in the list of the image file metadata information sequentially corresponds to each URI in the variable CurrentURIList in a one-to-one manner.

After the DMR acquires the to-be-presented media file, that is, the URI list of the multiple images, the DMS compresses and packs the multiple to-be-presented images into a file, and transfers the file to the DMR by using the HTTP protocol, and the DMR receives the compressed file, so as to acquire the multiple images corresponding to the multiple URIs from the DMS.

S703. Present together, according to the media playback message, the multiple images corresponding to the multiple uniform resource identifiers.

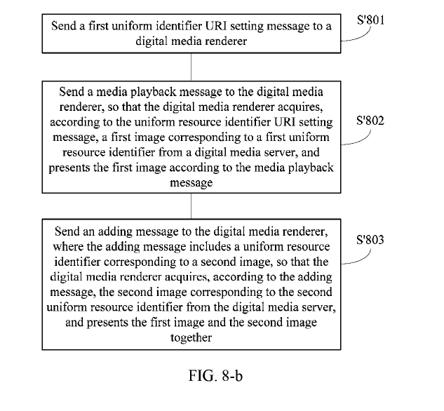

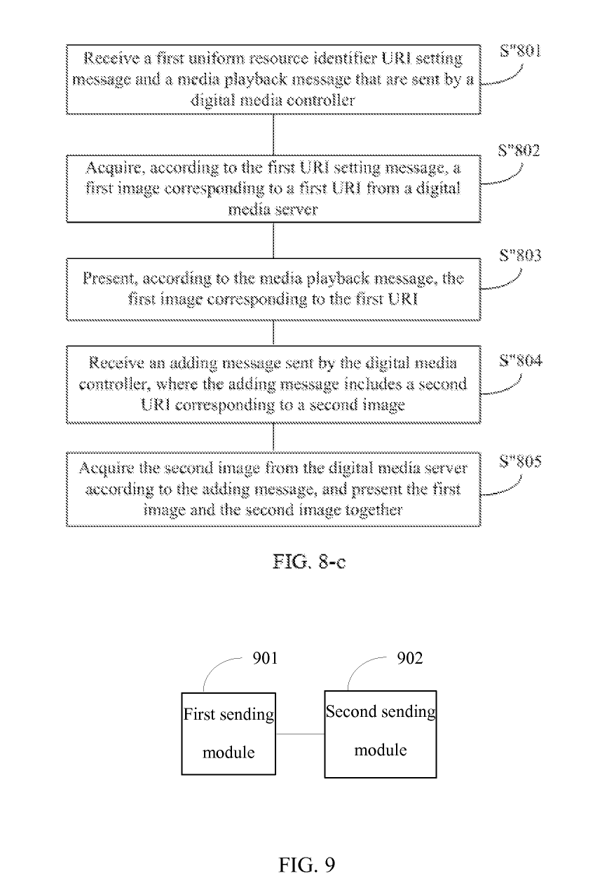

After the DMR receives a compressed package of the image file and obtains, by decompressing, data of the multiple to-be-presented images, an image display size and a display position in a screen are set and adjusted according to information (refer to a bold italic part in request packet in the foregoing example), such as an image size and a resolution in the variable CurrentURIListMetaData in the AVT::SetAVTransportURIList( ) action that is invoked by the DMC to the DMR. A specific procedure is shown in FIG. 8-a, including:

S801. Acquire image file metadata information of each image from the AVT::SetAVTransportURIList( ) action.

S802. Calculate a length-width ratio of each image in the multiple images according to a list of multiple pieces of image file metadata information.

As described above, the first uniform resource identifier URI list setting message sent by the DMC to the DMR not only includes a list of the multiple uniform resource identifiers respectively corresponding to the multiple images, but also may include the list of the multiple pieces of image file metadata information respectively corresponding to the multiple uniform resource identifiers. Therefore, the DMR may calculate the length-width ratio of each image in the multiple images according to the list of the multiple pieces of image file metadata information.

S803. Determine whether each image in the multiple images is equal in length-width ratio; if the length-to-width ratio of each image in the multiple images is not equal, perform step S804, and if the length-to-width ratio of each image in the multiple images is equal, directly perform step S805.

S804. Adjust the length-width ratio of each image in the multiple images so that each image in the multiple images is equal in length-width ratio.

S805. Zoom, by an equal proportion, each image that is equal in length-width ratio so that each image in the multiple images is equal in size.

S806. Arrange and display, according to a listing sequence of the multiple corresponding uniform resource identifiers, the multiple images that are equal in size.

In an actual application scenario of the multiple images, performing deletion, transposition, substitution, and the like on the multiple images presented in the screen are operations that are often performed by the user, and actually, these operations are also presenting manner changes performed on the presented images. As an embodiment of the present invention, after the multiple images corresponding to the multiple URIs are presented at the same time in the digital media renderer, a presenting manner change message sent by the digital media controller may also be received, and a presenting manner of the multiple images in the digital media renderer is changed according to the presenting manner change message.

As an embodiment in which the presenting manner change message sent by the digital media controller is received and the presenting manner of the multiple images in the digital media renderer is changed according to the presenting manner change message, a second uniform resource identifier URI list setting message that is sent by the digital media controller and includes multiple uniform resource identifiers listed according to a sequence may be received, multiple images corresponding to the multiple uniform resource identifiers listed according to a sequence are arranged and displayed according to the sequence. For example, according to the foregoing example of the request packet of invoking the AVT::SetAVTransportURIList( ) action, a listing sequence of the URIs in the CurrentURIList is as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

According to the foregoing URI listing sequence, when image 1 (that is, image1.jpg), image 2 (that is, image2.jpg), and image 3 (that is, image3.jpg) are displayed in the DMR, image 1, image 2, and image 3 are sequentially arranged in a left-to-right sequence, as shown in FIG. 3-a.

To meet a requirement, now it is required to change the arrangement sequence of the three images. For example, image 3, image 2, and image 1 are required to be sequentially displayed in the DMR in a left-to-right sequence. In this case, the DMC may invoke the AVT::SetAVTransportURIList( ) action to the DMR to implement the receiving, by the DMR, of the second uniform resource identifier URI list setting message that includes multiple URIs listed according to a sequence, and a sequence of the URIs listed in the CurrentURIList in the request packet of the AVT::SetAVTransportURIList( ) action is as follows:

<CurrentURIList>
<CurrentURI>http://10.11.85.185/53235/image3.jpg</CurrentURI>
<CurrentURI>http://10.11.85.185/53235/image2.jpg</CurrentURI>
<CurrentURI>http://10.11.85.185/53235/image1.jpg</CurrentURI>
</CurrentURIList>

According to the foregoing URI listing sequence, when image 1 (that is, image1.jpg), image 2 (that is, image2.jpg), and image 3 (that is, image3.jpg) are presented in the DMR, the three images corresponding to the multiple URIs listed according to the sequence are displayed and presented according to a sequence corresponding to the URI listing sequence, that is, image 3, image 2, and image 1 are sequentially arranged in a left-to-right sequence, as shown in FIG. 3-b.

As another embodiment in which the presenting manner change message sent by the digital media controller is received and the presenting manner of the multiple images in the digital media renderer is changed according to the presenting manner change message, the digital media renderer may receive a third uniform resource identifier URI list setting message that is sent by the digital media controller and includes a uniform resource identifier corresponding to a newly-added image, and present original images and the newly-added image together according to the third uniform resource identifier URI list setting message. For example, it is assumed that when the DMC previously invokes the AVT::SetAVTransportURIList( ) action to the DMR, an objective is to present only two images together in the DMR, such as image 1 (that is, image1.jpg) and image 2 (that is, image2.jpg), as shown in FIG. 4-a. That is, the variable CurrentURIList in the AVT::SetAVTransportURIList( ) action is described as follows:

<CurrentURIList>
<CurrentURI>http://10.11.85.185/53235/image1.jpg</CurrentURI>
<CurrentURI>http://10.11.85.185/53235/image2.jpg</CurrentURI>
</CurrentURIList>

Now it is required to add one image to the DMR, such as image 3 (that is, image3.jpg). Then the DMC may invoke the AVT::SetAVTransportURIList( ) action to the DMR to implement the receiving, by the DMR, of the third uniform resource identifier URI list setting message that includes the URI corresponding to the newly-added image, where the variable CurrentURIList in the AVT::SetAVTransportURIList( ) action (it is assumed that image 1, image 2, and image 3 are displayed in the DMR in a left-to-right sequence) is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

It can be learned from a comparison that, a URI of the newly-added image 3 (image3.jpg) is added to the variable CurrentURIList, and the original images and the newly-added image are presented at the same time in the DMR, that is, image 1 (that is, image1.jpg), image 2 (that is, image2.jpg), and the newly-added image 3 (that is, image3.jpg) are presented at the same time in the DMR, as shown in FIG. 4-b.

It should be noted that, because the newly-added image may have existed in a cache of the digital media renderer, and therefore, it is not required to deliver the newly-added image from the digital media server again. In this case, to save resources, in the foregoing embodiment in which the digital media renderer receives the third uniform resource identifier URI list setting message that is sent by the digital media controller and includes the uniform resource identifier corresponding to the newly-added image, and presents the original images and the newly-added image together according to the third uniform resource identifier URI list setting message, before the third uniform resource identifier URI list setting message that is sent by the digital media controller and includes the uniform resource identifier corresponding to the newly-added image is received, it may be determined whether a local cache of the digital media renderer saves image data corresponding to the newly-added image, if the image data corresponding to the newly-added image is saved, it is not required to request the digital media server to transfer the image data corresponding to the newly-added image, and otherwise, a request packet for requesting to transfer the newly-added image is sent to the digital media server to request the digital media server to transfer the image data corresponding to the newly-added image.

As another embodiment in which the presenting manner change message sent by the digital media controller is received and the presenting manner of the multiple images in the digital media renderer is changed according to the presenting manner change message, the digital media renderer may receive a fourth uniform resource identifier URI list setting message that is sent by the digital media controller and includes a URI corresponding to an image that is reserved to be presented, and present, at the same time and according to the fourth uniform resource identifier URI list setting message, the image that is reserved to be presented. For example, it is assumed that when the DMC previously invokes the AVT::SetAVTransportURIList( ) action to the DMR, an operation result is that four images are presented together in the DMR, such as image 1 (that is, image1.jpg), image 2 (that is, image2.jpg), image 3 (that is, image3.jpg), and image 4 (that is, image4.jpg), as shown in FIG. 5-a. That is, the variable CurrentURIList in the AVT::SetAVTransportURIList( ) action is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
<CurrentURI>http://10.11.85.185/53235/image4.jpg</CurrentURI>
</CurrentURIList>

Now it is required to delete one image. For example, it is required to delete image 4 (that is, image4.jpg). In this case, the DMC may invoke the AVT::SetAVTransportURIList( ) action to the DMR to implement the receiving, by the DMR, of the fourth uniform resource identifier URI list setting message that is sent by the digital media controller and includes the uniform resource identifier corresponding to the image that is reserved to be presented, where the variable CurrentURIList in the AVT::SetAVTransportURIList( ) action (it is assumed that image 1, image 2, and image 3 are displayed in the DMR in a left-to-right sequence) is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

It can be learned from a comparison that, a URI of the deleted image 4 (image4.jpg) is removed from the variable CurrentURIList, and only the image that is reserved to be presented is presented at the same time in the DMR, that is, image 1 (that is, image1.jpg), image 2 (that is, image2.jpg), and image 3 (that is, image3.jpg) are presented together in the DMR, as shown in FIG. 5-b.

As another embodiment in which the presenting manner change message sent by the digital media controller is received and the presenting manner of the multiple images in the digital media renderer is changed according to the presenting manner change message, the digital media renderer may receive a fifth uniform resource identifier URI list setting message that is sent by the digital media controller and includes a uniform resource identifier corresponding to a substituting image, and present a non-substituted image and the substituting image together according to the fifth uniform resource identifier URI list setting message. For example, it is assumed that when the DMC previously invokes the AVT::SetAVTransportURIList( ) action to the DMR, an operation result is that three images are presented together in the DMR, such as image 1 (that is, image1.jpg), image 2 (that is, image2.jpg), and image 3 (that is, image3.jpg), as shown in FIG. 6-a. That is, the variable CurrentURIList in the AVT::SetAVTransportURIList( ) action is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image3.jpg</CurrentURI>
</CurrentURIList>

Now it is required to substitute one of the images. For example, image 3 (that is, image3.jpg) is substituted by image 4 (that is, image4.jpg). In this case, the DMC may invoke the AVT::SetAVTransportURIList( ) action to the DMR to implement the receiving, by the DMR, of the fifth uniform resource identifier URI list setting message that is sent by the digital media controller and includes the uniform resource identifier corresponding to the substituting image, where the variable CurrentURIList in the AVT::SetAVTransportURIList( ) action (it is assumed that image 1, image 2, and image 4 are displayed in the DMR in a left-to-right sequence) is described as follows:

<CurrentURIList>
<CurrentURI>http://10.11.85.185/53235/image1.jpg</CurrentURI>
<CurrentURI>http://10.11.85.185/53235/image2.jpg</CurrentURI>
<CurrentURI>http://10.11.85.185/53235/image4.jpg</CurrentURI>
</CurrentURIList>

It can be learned from a comparison that, in the variable CurrentURIList, a URI of the deleted image 3 (image3.jpg) is substituted by a URI of image 4 (image4.jpg), and the non-substituted image and the substituted image are presented at the same time in the DMR, that is, image 1 (that is, image1.jpg), image 2 (that is, image2.jpg), and the substituted image 4 (that is, image4.jpg) are presented together in the DMR, as shown in FIG. 6-b.

It should be noted that, because the deletion, transposition, substitution, and the like of the images in the digital media renderer may change a layout of the original images, and therefore, in this embodiment of the present invention, after the presenting manner of the multiple images in the digital media renderer is changed according to the presenting manner change message, a size and/or a position, in the digital media renderer, of each image in multiple images that are re-presented according to the presenting manner may be further adjusted. A specific adjusting method may use the method, shown in FIG. 8-a, for presenting, at the same time, the multiple images corresponding to the multiple URIs, and details are not described herein again.

In the foregoing embodiment of the present invention, the digital media controller sends the uniform resource identifier URI list setting message formed by the multiple URIs corresponding to the multiple images to the digital media renderer. In this embodiment, the digital media server pushes at the same time the multiple images corresponding to the multiple URIs to the digital media renderer. The following gives another embodiment, and in this embodiment, the digital media controller sends a uniform resource identifier URI setting message formed by one URI corresponding to one image to the digital media renderer each time, and sends the uniform resource identifier URI setting message for multiple times, specifically, as shown in FIG. 8-b, and detailed description is as follows:

S′801. Send a first uniform resource identifier URI setting message to a digital media renderer, where the first uniform resource identifier URI setting message includes a first uniform resource identifier corresponding to a first image.

Similar to the foregoing embodiment of the present invention, the sending a first uniform resource identifier URI setting message may also be implemented by invoking an AVT::SetAVTransportURIList( ) action by the DMC to the DMR. A difference is that the first uniform resource identifier URI setting message sent each time by the DMC to the digital media renderer includes only one URI corresponding to one image.

S′802. Send a media playback message to the digital media renderer, so that the digital media renderer acquires, according to the uniform resource identifier URI setting message, the first image corresponding to the first uniform resource identifier from a digital media server, and presents the first image according to the media playback message.

Similar to the foregoing embodiment of the present invention, the sending a media playback message by the DMC to the digital media renderer may also be implemented by invoking an AVT::Play( ) action to the digital media renderer.

S′803. Send an adding message to the digital media renderer, where the adding message includes a uniform resource identifier corresponding to a second image, so that the digital media renderer acquires, according to the adding message, the second image corresponding to the second uniform resource identifier from the digital media server, and presents the first image and the second image together.

In step S′803, the adding message sent by the DMC to the digital media renderer includes the uniform resource identifier corresponding to the second image. It should be noted that, the “second image” herein not merely refers to one image, that is, “the second image”, but one image or multiple images that is/are different from the “first image”; if the “second image” merely refers to one image, that is, “the second image”, the adding message includes one uniform resource identifier corresponding to “the second image”; and if the “second image” refers to multiple images, the adding message includes a list of multiple uniform resource identifiers corresponding to the multiple images.

In addition, it should also be noted that the DMC that sends the adding message to the digital media renderer may be the same as the DMC that sends the first uniform resource identifier URI setting message to the digital media renderer, or may be different from the DMC that sends the first uniform resource identifier URI setting message to the digital media renderer, which is not limited in the present invention.

Reference is made to FIG. 8-c, which is a schematic flowchart of a method for presenting multiple images according to another embodiment of the present invention, and an execution body of the method may be a digital media renderer (DMR) in a home network provided in this embodiment of the present invention. The method shown in FIG. 8-c mainly includes step S″801 to step S″805, and the method is described in detail as follow:

S″801. Receive a first uniform resource identifier URI setting message and a media playback message that are sent by a digital media controller, where the first URI setting message includes a first URI corresponding to a first image.

Similar to the foregoing embodiment of the present invention, sending the first uniform resource identifier URI setting message by the digital media controller may also be implemented by invoking an AVT::SetAVTransportURIList( ) action by the DMC to the DMR. A difference is that the first uniform resource identifier URI setting message sent each time by the DMC to the digital media renderer includes only one URI corresponding to one image.

S″802. Acquire, according to the first URI setting message, the first image corresponding to the first URI from a digital media server.

S″803. Present, according to the media playback message, the first message corresponding to the first URI.

S″804. Receive an adding message sent by the digital media controller, where the adding message includes a second URI corresponding to a second image.

It should be noted that, in step S″804, the DMC that sends the adding message may be the same as the DMC that sends the first uniform resource identifier URI setting message to the digital media renderer, or may be different from the DMC that sends the first uniform resource identifier URI setting message to the digital media renderer, which is not limited in the present invention.

In addition, it should also be noted that the “second image” in step S″804 not merely refers to one image, that is, “the second image”, but one image or multiple images that is/are different from the “first image”; if the “second image” merely refers to one image, that is, “the second image”, the adding message includes one uniform resource identifier corresponding to “the second image”; and if the “second image” refers to multiple images, the adding message includes a list of multiple uniform resource identifiers corresponding to the multiple images.

S″805. Acquire the second image from the digital media server according to the adding message, and present the first image and the second image together.

Reference is made to FIG. 9, which is a schematic structural diagram of an apparatus for presenting multiple images according to an embodiment of the present invention. For ease of description, only parts related to this embodiment of the present invention are shown. The apparatus, shown in FIG. 9, for presenting the multiple images may be a digital media controller in a home network. The apparatus, shown in FIG. 9, for presenting the multiple images includes a first sending module 901, and a second sending module 902.

The first sending module 901 is configured to send a first uniform resource identifier URI list setting message to a digital media renderer, where the first uniform resource identifier URI list setting message includes a list of multiple uniform resource identifiers respectively corresponding to the multiple images, so that the digital media renderer acquires, according to the first URI list setting message, the multiple images corresponding to the multiple uniform resource identifiers from a digital media server.

The first uniform resource identifier URI list setting message not only includes the list of the multiple uniform resource identifiers respectively corresponding to the multiple images, but also may include a list of multiple pieces of image file metadata information respectively corresponding to the multiple uniform resource identifiers. For details, refer to the foregoing embodiment, which are not described herein again.

The second sending module 902 is configured to send a media playback message to the digital media renderer, so that the digital media renderer presents the multiple images together according to the media playback message.

It should be noted that, in the foregoing implementation manner of the apparatus for presenting the multiple images, division of each functional module is only an example for description. In an actual application, according to a requirement, for example, according to a configuration requirement of corresponding hardware or consideration of convenience for implementation of software, the foregoing functions may be allocated to different functional modules for completion. That is, internal structures of the apparatus for presenting the multiple images are divided into different functional modules, so as to complete all or a part of functions described above. In addition, in an actual application, the corresponding functional modules in this embodiment may be implemented by corresponding hardware, or may be completed by corresponding hardware by executing corresponding software; for example, the foregoing first sending module may be hardware, such as a first transmitter, that has a function of implementing the foregoing sending of a first uniform resource identifier URI list setting message to a digital media renderer, or may be a universal processor or another hardware device that can execute a corresponding computer program to complete the foregoing functions; for another example, the foregoing second sending module may be hardware, such as a second transmitter, that has a function of implementing the foregoing sending a media playback message to the digital media renderer so that the digital media renderer presents the multiple images together according to the media playback message, or may be a universal processor or another hardware device that can execute a corresponding computer program to complete the foregoing functions (The principle described in the foregoing may be applied to each embodiment provided in this specification).

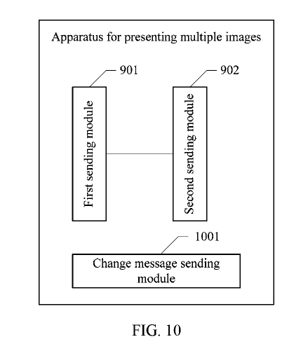

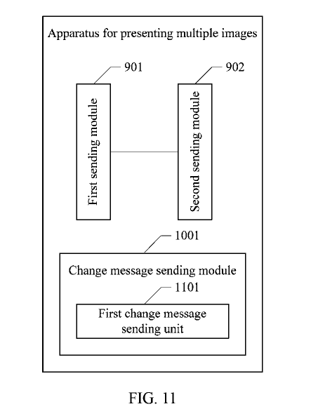

The apparatus shown in FIG. 9 may also include a change message sending module 1001, as shown in FIG. 10, which shows an apparatus for presenting multiple images according to another embodiment of the present invention. The change message sending module 1001 is configured to send a presenting manner change message to the digital media renderer, so that the digital media renderer changes a presenting manner of the multiple images in the digital media renderer.

The change message sending module 1001 shown in FIG. 10 may include a first change message sending unit 1101, as shown in FIG. 11, which shows an apparatus for presenting multiple images according to another embodiment of the present invention. The first change message sending unit 1101 is configured to send a second uniform resource identifier URI list setting message that includes multiple uniform resource identifiers listed according to a sequence to the digital media renderer, so that the digital media renderer arranges and displays, according to a sequence corresponding to the listing sequence of the multiple uniform resource identifiers, multiple images corresponding to the multiple uniform resource identifiers listed according to the sequence.

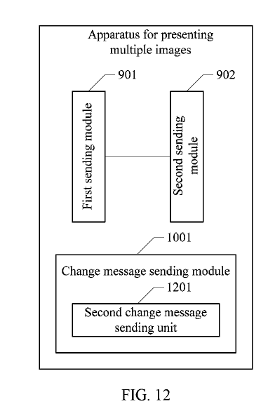

The change message sending module 1001 shown in FIG. 10 may also include a second change message sending unit 1201, as shown in FIG. 12, which shows an apparatus for presenting multiple images according to another embodiment of the present invention. The second change message sending unit 1201 is configured to send a third uniform resource identifier URI list setting message that includes a uniform resource identifier corresponding to a newly-added image to the digital media renderer, so that the digital media renderer presents original images and the newly-added image together.

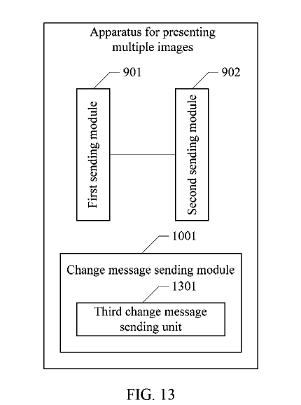

The change message sending module 1001 shown in FIG. 10 may also include a third change message sending unit 1301, as shown in FIG. 13, which shows an apparatus for presenting multiple images according to another embodiment of the present invention. The third change message sending unit 1301 is configured to send, to the digital media renderer, a fourth uniform resource identifier URI list setting message that includes a uniform resource identifier corresponding to an image that is reserved to be presented, so that the digital media renderer presents together only the image that is reserved to be presented.

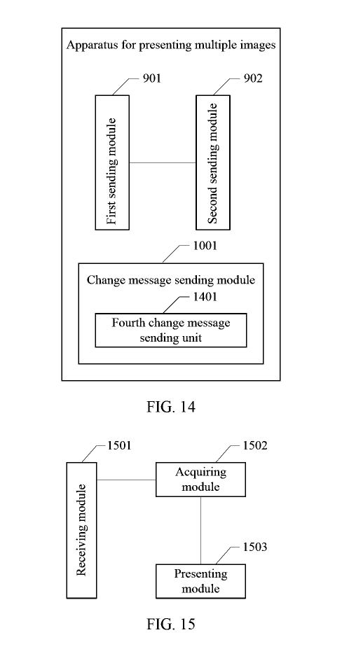

The change message sending module 1001 shown in FIG. 10 may also include a fourth change message sending unit 1401, as shown in FIG. 14, which shows an apparatus for presenting multiple images according to another embodiment of the present invention. The fourth change message sending unit 1401 is configured to send a fifth uniform resource identifier URI list setting message that includes a uniform resource identifier corresponding to a substituting image to the digital media renderer, so that the digital media renderer presents a non-substituted image and the substituting image together.

Reference is made to FIG. 15, which is a schematic structural diagram of an apparatus for presenting multiple images according to another embodiment of the present invention. For ease of description, only parts related to this embodiment of the present invention are shown. The apparatus, shown in FIG. 15, for presenting the multiple images may be a digital media renderer in a home network. The apparatus, shown in FIG. 15, for presenting the multiple images includes a receiving module 1501, an acquiring module 1502, and a presenting module 1503.

The receiving module 1501 is configured to receive a first uniform resource identifier URI list setting message and a media playback message that are sent by a digital media controller, where the first uniform resource identifier URI list setting message includes a list of multiple uniform resource identifiers respectively corresponding to the multiple images.

The first uniform resource identifier URI list setting message not only includes the list of the multiple uniform resource identifiers respectively corresponding to the multiple images, but also may include a list of multiple pieces of image file metadata information respectively corresponding to the multiple uniform resource identifiers. For details, refer to the foregoing embodiment, which are not described herein again.

The acquiring module 1502 is configured to acquire, according to the first uniform resource identifier URI list setting message, the multiple images corresponding to the multiple uniform resource identifiers from a digital media server.

The presenting module 1503 is configured to present together, according to the media playback message, the multiple images corresponding to the multiple uniform resource identifiers.

It should be noted that, in the foregoing implementation manner of the apparatus for presenting the multiple images, division of each functional module is only an example for description. In an actual application, according to a requirement, for example, according to a configuration requirement of corresponding hardware or consideration of convenience for implementation of software, the foregoing functions may be allocated to different functional modules for completion. That is, internal structures of the apparatus for presenting the multiple images are divided into different functional modules, so as to complete all or a part of functions described above. In addition, in an actual application, the corresponding functional modules in this embodiment may be implemented by corresponding hardware, or may be completed by corresponding hardware by executing corresponding software; for example, the foregoing receiving module may be hardware, such as a receiver, that has a function of implementing the foregoing receiving of a first uniform resource identifier URI list setting message and a media playback message that are sent by a digital media controller, or may be a universal processor or another hardware device that can execute a corresponding computer program to complete the foregoing functions; for another example, the foregoing acquiring module may be hardware, such as an acquirer, that has a function of implementing the foregoing acquiring, according to the first uniform resource identifier URI list setting message, of the multiple images corresponding to the multiple uniform resource identifiers from a digital media server, or may be a universal processor or another hardware device that can execute a corresponding computer program to complete the foregoing functions (The principle described in the foregoing may be applied to each embodiment provided in this specification).

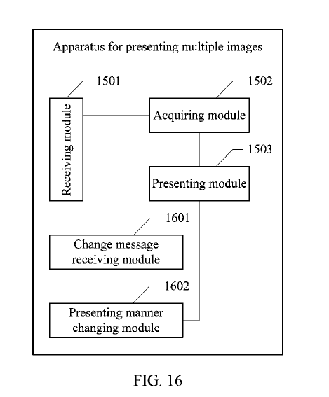

The apparatus shown in FIG. 15 may also include a change message receiving module 1601 and a presenting manner changing module 1602, as shown in FIG. 16, which shows an apparatus for presenting multiple images according to another embodiment of the present invention.

The change message receiving module 1601 is configured to receive a presenting manner change message sent by the digital media controller.

The presenting manner changing module 1602 is configured to change a presenting manner of the multiple images in the digital media renderer according to the presenting manner change message.

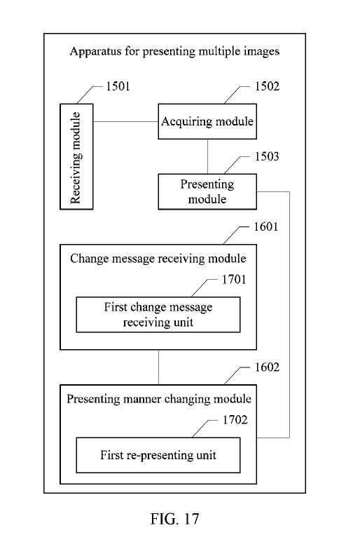

The change message receiving module 1601 shown in FIG. 16 may include a first change message receiving unit 1701, and the presenting manner changing module 1602 may include a first re-presenting unit 1702, as shown in FIG. 17, which shows an apparatus for presenting multiple images according to another embodiment of the present invention.

The first change message receiving unit 1701 is configured to receive a second uniform resource identifier URI list setting message that is sent by the digital media controller and includes multiple uniform resource identifiers listed according to a sequence.

The first re-presenting unit 1702 is configured to arrange and display, according to the sequence of listing the multiple uniform resource identifiers, multiple images corresponding to the multiple uniform resource identifiers listed according to the sequence.

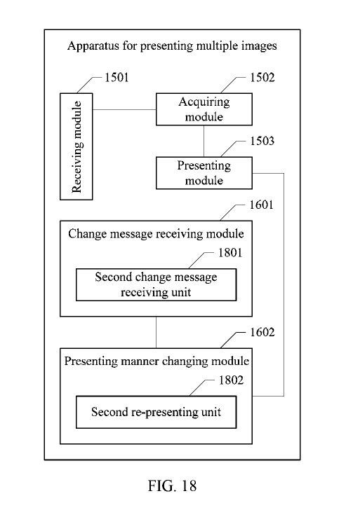

The change message receiving module 1601 shown in FIG. 16 may also include a second change message receiving unit 1801, and the presenting manner changing module 1602 may also include a second re-presenting unit 1802, as shown in FIG. 18, which shows an apparatus for presenting multiple images according to another embodiment of the present invention.

The second change message receiving unit 1801 is configured to receive a third uniform resource identifier URI list setting message that is sent by the digital media controller and includes a uniform resource identifier corresponding to a newly-added image.

The second re-presenting unit 1802 is configured to present original images and the newly-added image together according to the third uniform resource identifier URI list setting message.

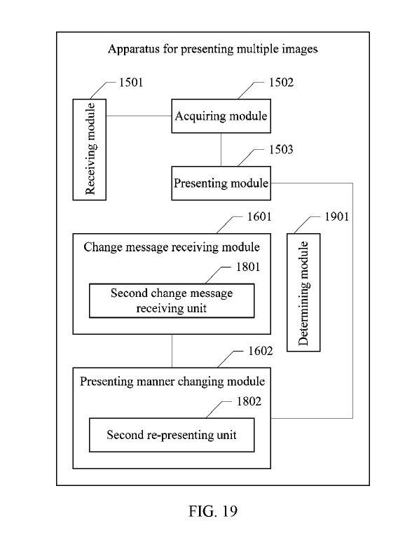

The apparatus shown in FIG. 18 may also include a determining module 1901, as shown in FIG. 19, which shows an apparatus for presenting multiple images according to another embodiment of the present invention. The determining module 1901 is configured to determine whether the apparatus, shown in FIG. 19, for presenting the multiple images locally saves image data corresponding to the newly-added image.

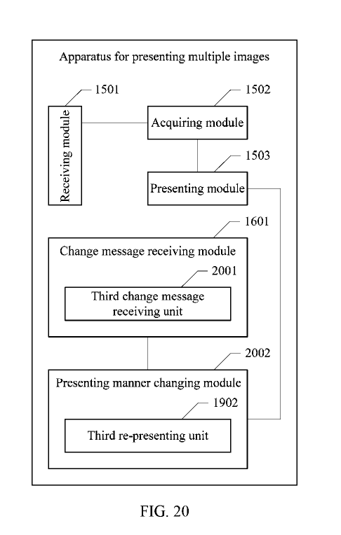

The change message receiving module 1601 shown in FIG. 16 may also include a third change message receiving unit 2001, and the presenting manner changing module 1602 may also include a third re-presenting unit 2002, as shown in FIG. 20, which shows an apparatus for presenting multiple images according to another embodiment of the present invention.

The third change message receiving unit 2001 is configured to receive a fourth uniform resource identifier URI list setting message that is sent by the digital media controller and includes a uniform resource identifier corresponding to an image that is reserved to be presented.

The third re-presenting unit 2002 is configured to present, at the same time and according to the fourth uniform resource identifier URI list setting message, only the image that is reserved to be presented.

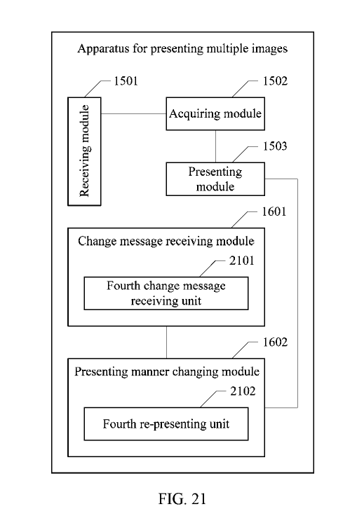

The change message receiving module 1601 shown in FIG. 16 may also include a fourth change message receiving unit 2101, and the display manner changing module 1602 may also include a fourth re-presenting unit 2102, as shown in FIG. 21, which shows an apparatus for presenting multiple images according to another embodiment of the present invention.

The fourth change message receiving unit 2101 is configured to receive a fifth uniform resource identifier URI list setting message that is sent by the digital media controller and includes a uniform resource identifier corresponding to a substituting image.

The fourth re-presenting unit 2102 is configured to present a non-substituted image and the substituting image together according to the fifth uniform resource identifier URI list setting message.

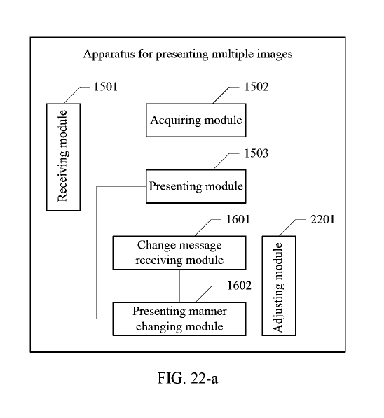

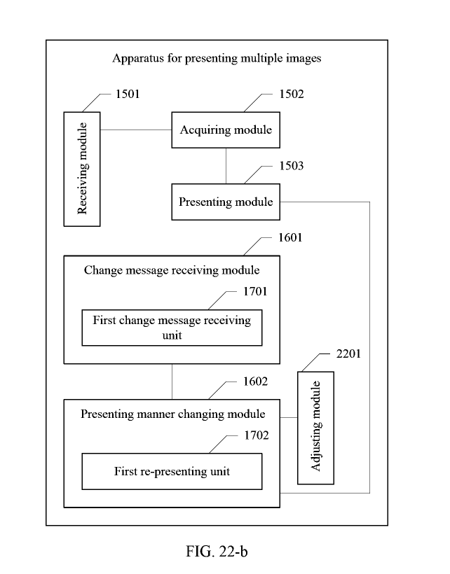

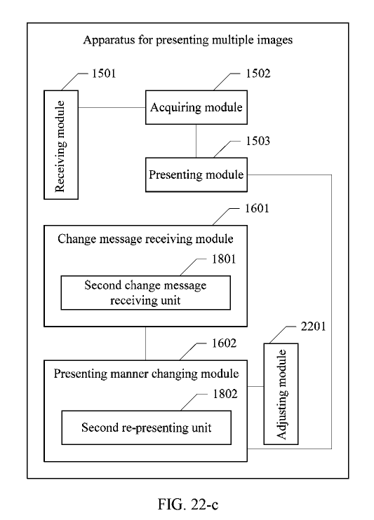

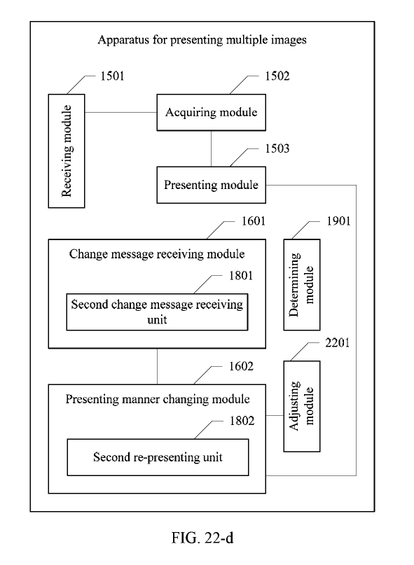

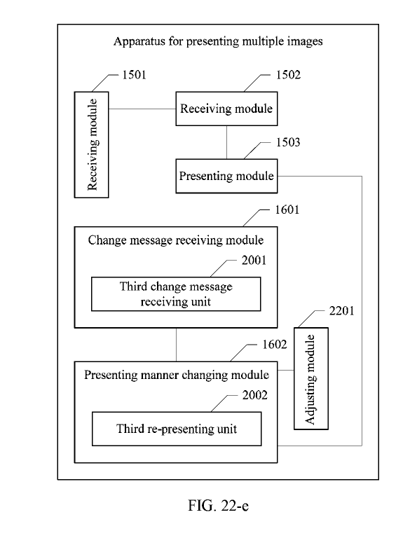

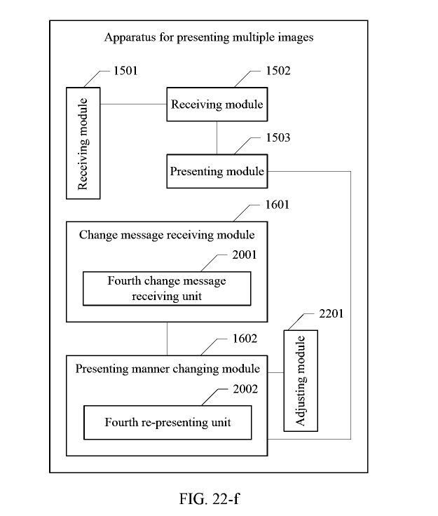

Any apparatus shown in FIG. 16 to FIG. 21 may also include an adjusting module 2201, as shown in FIG. 22-a to FIG. 22-f, which show apparatuses for presenting multiple images according to another embodiment of the present invention. The adjusting module 2201 is configured to adjust a size and/or a position of each image in multiple images that are re-presented according to the presenting manner.

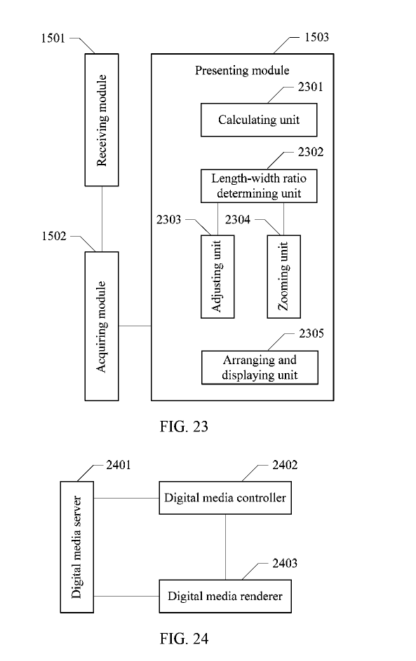

The presenting module 1503 shown in FIG. 15 may include a calculating unit 2301, a length-width ratio determining unit 2302, an adjusting unit 2303, a zooming unit 2304, and an arranging and displaying unit 2305, as shown in FIG. 23, which shows an apparatus for presenting multiple images according to another embodiment of the present invention.

The calculating unit 2301 is configured to calculate a length-width ratio of each image in the multiple images according to a list of multiple pieces of image file metadata information.

As described above, the first uniform resource identifier URI list setting message sent by the DMC to the DMR not only includes a list of the multiple uniform resource identifiers respectively corresponding to the multiple images, but also may include the list of the multiple pieces of image file metadata information respectively corresponding to the multiple uniform resource identifiers. Therefore, the calculating unit 2301 may calculate the length-width ratio of each image in the multiple images according to the list of the multiple pieces of image file metadata information.

The length-width ratio determining unit 2302 is configured to determine whether each image in the multiple images is equal in length-width ratio.

The adjusting unit 2303 is configured to: if a result determined by the length-width ratio determining unit 2302 is not equal, adjust the length-width ratio of each image in the multiple images so that each image in the multiple images is equal in length-width ratio.

The zooming unit 2304 is configured to zoom, by an equal proportion, each image that is equal in length-width ratio so that each image in the multiple images is equal in size.

The arranging and displaying unit 2305 is configured to arrange and display, according to a listing sequence of the multiple corresponding uniform resource identifiers, the multiple images that are equal in size.

Reference is made to FIG. 24, which is a schematic structural diagram of a home network system for presenting multiple images according to an embodiment of the present invention. For ease of description, only parts related to this embodiment of the present invention are shown. A home network system, shown in FIG. 24, for presenting the multiple images includes a digital media server 2401, the digital media controller 2402 provided in any embodiment according to FIG. 9 to FIG. 14, and the digital media renderer 2403 provided in any embodiment according to FIG. 15 to FIG. 23.

The digital media server 2401 is configured to transfer the multiple images to the digital media renderer 2403 under control of the digital media controller 2402.

The digital media controller 2402 is configured to send a first uniform resource identifier URI list setting message and send a media playback message to the digital media renderer 2403, so that the digital media renderer 2403 acquires, according to the first uniform resource identifier URI list setting message, multiple images corresponding to multiple uniform resource identifiers from the digital media server 2401, and presents the multiple images together according to the media playback message, where the first uniform resource identifier URI list setting message not only includes a list of the multiple uniform resource identifiers respectively corresponding to the multiple images, but also may include a list of multiple pieces of image file metadata information respectively corresponding to the multiple uniform resource identifiers.

The digital media renderer 2403 is configured to: receive the first uniform resource identifier URI list setting message and the media playback message that are sent by the digital media controller 2402; acquire, according to the first uniform resource identifier URI list setting message, the multiple images corresponding to the multiple uniform resource identifiers from the digital media server 2401; and present together, according to the media playback message, the multiple images corresponding to the multiple uniform resource identifiers.

Specifically, in the home network system, shown in FIG. 24, for presenting the multiple images, the digital media server 2401 is a home network device for storing an image file and includes home network devices, such as a smartphone, a tablet computer, a digital camera, and a portable computer, which can generate and store an image file, such as a photo, and a slide; the digital media controller 2402 can invoke a related control action in the digital media server 2401 and the digital media renderer 2403 to perform control on image transfer and presentation; the digital media renderer 2403 is a presenting device that has a larger screen and a higher resolution, including a high definition television, a desktop computer, and the like, which can perform decoding on an image file and present and play images; and the digital media controller 2402 may be a physical device that is different from the digital media server 2401 and the digital media renderer 2403, and may also form a physical device together with the digital media server 2401 or the digital media renderer 2403.

In this embodiment of the present invention, for interaction between the digital media server 2401, the digital media controller 2402, and the digital media renderer 2403, refer to FIG. 2, and details are not described herein again.

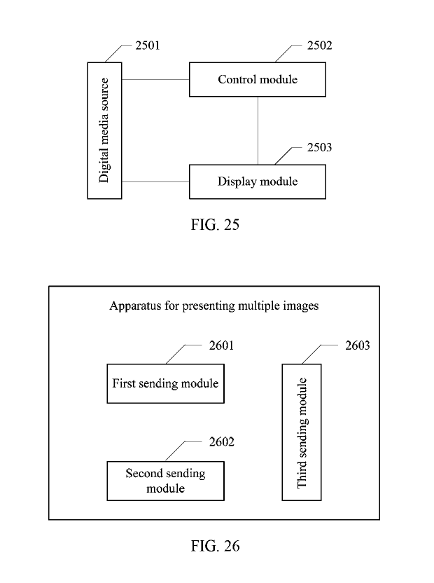

Reference is made to FIG. 25, which is a schematic structural diagram of a mobile terminal according to an embodiment of the present invention. For ease of description, only parts related to this embodiment of the present invention are shown. The mobile terminal shown in FIG. 25 includes a digital media source 2501, a control module 2502, and a display module 2503.

The digital media source 2501 is configured to transfer multiple images to the display module 2503 under control of the control module 2502.

The control module 2502 is configured to send a first uniform resource identifier URI list setting message and send a media playback message to the display module 2503, where the first uniform resource identifier URI list setting message not only includes a list of multiple uniform resource identifiers respectively corresponding to the multiple images, but also may include a list of multiple pieces of image file metadata information respectively corresponding to the multiple uniform resource identifiers.

The display module 2503 is configured to: receive the first uniform resource identifier URI list setting message and the media playback message that are sent by the control module 2502; acquire, according to the first uniform resource identifier URI list setting message, the multiple images corresponding to the multiple uniform resource identifiers from the digital media source 2501; and present together, according to the media playback message, the multiple images corresponding to the multiple uniform resource identifiers.

A mobile phone, a tablet computer, and the like are used as an example to describe that the mobile terminal shown in FIG. 25 is used in a user operation manner and a corresponding user interface design to push multiple images in a convenient and fast manner; and a multiple finger touch and slide operation is used during the push.

An image file is stored in the mobile terminal, such as the mobile phone and the tablet computer, and a mobile electronic device has functions of the DMS, the DMC, and the DMR, which respectively correspond to functions of the digital media source 2501, the control module 2502, and the display module 2503 in FIG. 25. The image file stored in the mobile terminal is displayed in a screen of the mobile terminal in a thumbnail form. When a multiple image pushing operation is performed, a user uses multiple fingers to click thumbnails of to-be-pushed images together, and then slides the thumbnails for a distance in any direction, and the multiple images are delivered to the display module 2503 and presented by using the screen of the mobile terminal. If there are many to-be-presented images, the user may also click and select thumbnails of the to-be-pushed image file one by one, and then slide the thumbnails for a distance in any direction, and the pushing operation is completed. In this case, an area appears in the screen of the mobile terminal to present the displayed images, and display sizes of the images are slightly larger than sizes of the thumbnails.

In the foregoing embodiment, the mobile terminal is divided into two areas, an upper area and a lower area, where the upper area is a display area, and thumbnails of the images presented by the display module 2503 are displayed in this area; and thumbnails of images that are not presented by the display module 2503 are displayed in the lower area, so that an action of changing a presenting manner of the images can be performed. For example, when the user uses two fingers to click thumbnails of two images in the upper area and then rotates the thumbnails, the display module 2503 may exchange positions of the two images; a thumbnail in the lower area is clicked and dragged to a middle part of two thumbnails in the upper area, the display module 2503 may implement an adding image operation, in this case, the newly-added image is displayed in the middle of the two original images; a thumbnail in the upper area is clicked and dragged to the lower part, and the image is removed from a screen of the DMR to complete picture deletion work; and a thumbnail in the lower area is clicked and dragged to a position of a thumbnail in the upper area, then an update operation is performed on the two images.

Reference is made to FIG. 26, which is a schematic structural diagram of an apparatus for presenting multiple images according to an embodiment of the present invention. For ease of description, only parts related to this embodiment of the present invention are shown. The apparatus, shown in FIG. 26, for presenting the multiple images may be a digital media controller in a home network and includes a first sending module 2601, a second sending module 2602, and a third sending module 2603.

The first sending module 2601 is configured to send a first uniform resource identifier URI setting message to a digital media renderer, where the first uniform resource identifier URI setting message includes a first uniform resource identifier corresponding to a first image.

The second sending module 2602 is configured to send a media playback message to the digital media renderer, so that the digital media renderer acquires, according to the uniform resource identifier URI setting message, the first image corresponding to the first uniform resource identifier from a digital media server, and presents the first image according to the media playback message.

The third sending module 2603 is configured to send an adding message to the digital media renderer, where the adding message includes a second uniform resource identifier corresponding to a second image, so that the digital media renderer acquires, according to the adding message, the second image corresponding to the second uniform resource identifier from the digital media server, and presents the first image and the second image together.

Reference is made to FIG. 27, which is a schematic structural diagram of an apparatus for presenting multiple images according to an embodiment of the present invention. For ease of description, only parts related to this embodiment of the present invention are shown. The apparatus, shown in FIG. 27, for presenting the multiple images may be a digital media renderer in a home network, where the apparatus includes a first receiving module 2701, a first acquiring module 2702, a presenting module 2703, a second receiving module 2704, and a second acquiring module 2705.

The first receiving module 2701 is configured to receive a first uniform resource identifier URI setting message and a media playback message that are sent by a digital media controller, where the first uniform resource identifier URI setting message includes a first uniform resource identifier corresponding to a first image.

The first acquiring module 2702 is configured to acquire, according to the first uniform resource identifier URI setting message and the media playback message, the first image corresponding to the first uniform resource identifier from a digital media server.

The presenting module 2703 is configured to present the first image corresponding to the first uniform resource identifier.

The second receiving module 2704 is configured to receive an adding message sent by the digital media controller, where the adding message includes a second uniform resource identifier corresponding to a second image.

The second acquiring module 2705 is configured to acquire, according to the adding message, the second image corresponding to the second uniform resource identifier from the digital media server.

The presenting module 2703 is further configured to present the first image and the second image together.

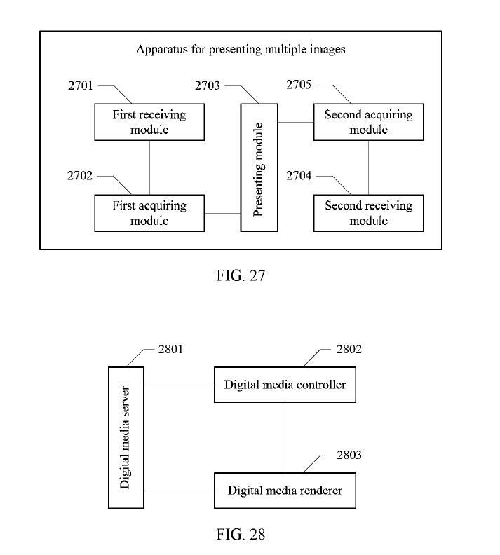

Reference is made to FIG. 28, which is a schematic structural diagram of a home network system for presenting multiple images according to an embodiment of the present invention. For ease of description, only parts related to this embodiment of the present invention are shown. A home network system, shown in FIG. 28, for presenting the multiple images includes a digital media server 2801, the digital media controller 2802 shown in FIG. 26, and the digital media renderer 2803 shown in FIG. 27.

The digital media server 2801 is configured to transfer the multiple images to the digital media renderer 2803 under control of the digital media controller 2802.

The digital media controller 2802 is configured to: send a first uniform resource identifier URI setting message to the digital media renderer 2803, where the first uniform resource identifier URI setting message includes a first uniform resource identifier corresponding to a first image; send a media playback message to the digital media renderer 2803, so that the digital media renderer 2803 acquires, according to the uniform resource identifier URI setting message, the first image corresponding to the first uniform resource identifier from the digital media server 2801, and presents the first image according to the media playback message; and send an adding message to the digital media renderer 2803, where the adding message includes a uniform resource identifier corresponding to a second image, so that the digital media renderer 2803 acquires the second image from the digital media server 2801 according to the adding message, and presents the first image and the second image together.

The digital media renderer 2803 is configured to: receive a first uniform resource identifier URI setting message and the media playback message that are sent by the digital media controller 2801, where the first URI setting message includes the first URI corresponding to the first image; acquire, according to the first URI setting message, the first image corresponding to the first URI from the digital media server 2801; present, according to the media playback message, the first image corresponding to the first URI; receive an adding message sent by the digital media controller 2802, where the adding message includes a second URI corresponding to a second image; and acquire the second image from the digital media server 2801 according to the adding message, and present the first image and the second image together.

It should be noted that, content such as information exchange between the modules/units of the apparatus and the execution processes thereof is based on the same idea as the method embodiments of the present invention, and produces the same technical effects as the method embodiments of the present invention. For the specific content, refer to the description in the method embodiments of the present invention, and details are not described herein again.

A person of ordinary skill in the art may understand that all or a part of the steps of various methods in the foregoing embodiments may be implemented by a program instructing relevant hardware, for example, one or more or all of the following methods:

Method 1: Sending a first uniform resource identifier URI list setting message to a digital media renderer, where the first uniform resource identifier URI list setting message includes a list of multiple uniform resource identifiers URIs respectively corresponding to multiple images, so that the digital media renderer acquires, according to the first URI list setting message, the multiple images corresponding to the multiple URIs from a digital media server; and sending a media playback message to the digital media renderer, so that the digital media renderer presents the multiple images together according to the media playback message.

Method 2: Receiving a first uniform resource identifier URI list setting message and a media playback message that are sent by a digital media controller, where the first URI list setting message includes a list of multiple URIs respectively corresponding to multiple images; acquiring, according to the first URI list setting message, the multiple images corresponding to the multiple URIs from a digital media server; and presenting together, according to the media playback message, the multiple images corresponding to the multiple URIs.

Method 3: Sending a first uniform resource identifier URI setting message to a digital media renderer, where the first uniform resource identifier URI setting message includes a first uniform resource identifier corresponding to a first image; sending a media playback message to the digital media renderer, so that the digital media renderer acquires, according to the first uniform resource identifier URI setting message, the first image corresponding to the first uniform resource identifier from a digital media server, and presents the first image according to the media playback message; and sending an adding message to the digital media renderer, where the adding message includes a uniform resource identifier corresponding to a second image, so that the digital media renderer acquires the second image from the digital media server according to the adding message, and presents the first image and the second image together.

Method 4: Receiving a first uniform resource identifier URI setting message and a media playback message that are sent by a digital media controller, where the first URI setting message includes a first URI corresponding to a first image; acquiring, according to the first URI setting message, the first image corresponding to the first URI from a digital media server; presenting together, according to the media playback message, the first image corresponding to the first URI; receiving an adding message sent by the digital media controller, where the adding message includes a second URI corresponding to a second image; and acquiring the second image from the digital media server according to the adding message, and presenting the first image and the second image together.

A person of ordinary skill in the art may understand that all or some of the steps of the methods in the embodiments may be implemented by a program instructing relevant hardware. The program may be stored in a computer-readable storage medium. The storage medium may include: a read-only memory (ROM), a random access memory (RAM), a magnetic disk, or an optical disc, or the like.

The foregoing provides detailed description on the method, apparatus, and home network system for presenting the multiple images, and the mobile terminal according to the embodiments of the present invention. In this specification, specific examples are used to describe the principle and implementation manners of the present invention, and the description of the foregoing embodiments is merely intended to help understand the method of the present invention and core ideas thereof. In addition, the person of ordinary skill in the art can make various modifications and variations to the invention with respect to specific implementation manners and application scopes according to the ideas of the invention. In conclusion, the content of the specification shall not be construed as a limitation on the present invention.

What is claimed is:

1. A method for presenting multiple images, wherein the method comprises:
sending a first uniform resource identifier (URI) list setting message to a digital media renderer, wherein the first URI list setting message comprises a list of multiple URIs respectively corresponding to the multiple images, so that the digital media renderer acquires, according to the first URI list setting message, the multiple images corresponding to the multiple URIs from a digital media server; and
sending a media playback message to the digital media renderer, so that the digital media renderer presents the multiple images together according to the media playback message.

2. The method according to claim 1, wherein after the sending a media playback message to the digital media renderer, the method further comprises: sending a presenting manner change message to the digital media renderer, so that the digital media renderer changes a presenting manner of the multiple images in the digital media renderer.

3. The method according to claim 2, wherein the sending a presenting manner change message to the digital media renderer comprises:
sending a second URI list setting message that comprises multiple URIs listed according to a sequence to the digital media renderer, so that the digital media renderer arranges and displays, according to the sequence, multiple images corresponding to the multiple URIs listed according to the sequence; or
sending a third URI list setting message that comprises a URI corresponding to a newly-added image to the digital media renderer, so that the digital media renderer presents the original images and the newly-added image together; or
sending, to the digital media renderer, a fourth URI list setting message that comprises a URI corresponding to an image that is reserved to be presented, so that the digital media renderer presents, at the same time, the image that is reserved to be presented; or
sending a fifth URI list setting message that comprises a URI corresponding to a substituting image to the digital media renderer, so that the digital media renderer presents a non-substituted image and the substituting image together.

4. A method for presenting multiple images, wherein the method comprises:
receiving a first uniform resource identifier (URI) list setting message and a media playback message that are sent by a digital media controller, wherein the first URI list setting message comprises a list of multiple URIs respectively corresponding to the multiple images;
acquiring, according to the first URI list setting message, the multiple images corresponding to the multiple URIs from a digital media server; and
presenting together, according to the media playback message, the multiple images corresponding to the multiple URIs.

5. The method according to claim 4, wherein after the presenting together the multiple images corresponding to the multiple URIs, the method further comprises:
receiving a presenting manner change message sent by the digital media controller; and
changing a presenting manner of the multiple images in the digital media renderer according to the presenting manner change message.

6. The method according to claim 5, wherein the receiving a presenting manner change message sent by the digital media controller comprises: receiving a second URI list setting message that is sent by the digital media controller and comprises multiple URIs listed according to a sequence; and the changing a presenting manner of the multiple images in the digital media renderer according to the presenting manner change message comprises: arranging and displaying, according to the sequence, multiple images corresponding to the multiple URIs listed according to the sequence; or
the receiving a presenting manner change message sent by the digital media controller comprises: receiving a third URI list setting message that is sent by the digital media controller and comprises a URI corresponding to a newly-added image; and the changing a presenting manner of the multiple images in the digital media renderer according to the presenting manner change message comprises: presenting the original images and the newly-added image together according to the third URI list setting message; or
the receiving a presenting manner change message sent by the digital media controller comprises: receiving a fourth URI list setting message that is sent by the digital media controller and comprises a URI corresponding to an image that is reserved to be presented; and the changing a presenting manner of the multiple images in the digital media renderer according to the presenting manner change message comprises: presenting, at the same time and according to the fourth URI list setting message, the image that is reserved to be presented; or
the receiving a presenting manner change message sent by the digital media controller comprises: receiving a fifth URI list setting message that is sent by the digital media controller and comprises a URI corresponding to a substituting image; and the changing a presenting manner of the multiple images in the digital media renderer according to the presenting manner change message comprises: presenting a non-substituted image and the substituting image together according to the fifth URI list setting message.

7. The method according to claim 5, wherein after the changing a presenting manner of the multiple images in the digital media renderer according to the presenting manner change message, the method further comprises: adjusting a size and/or a position, in the digital media renderer, of each image in the multiple images that are re-presented according to the presenting manner.

8. The method according to claim 4, wherein the presenting together the multiple images corresponding to the multiple URIs comprises:
calculating a length-width ratio of each image in the multiple images according to a list of multiple pieces of image file metadata information;
determining whether each image in the multiple images is equal in length-width ratio;
if each image in the multiple images is not equal in length-width ratio, adjusting the length-width ratio of each image in the multiple images so that each image in the multiple images is equal in length-width ratio;
zooming, by an equal proportion, each image that is equal in length-width ratio so that each image in the multiple images is equal in size; and
arranging and displaying, according to a listing sequence of the multiple corresponding URIs, the multiple images that are equal in size.

9. A method for presenting multiple images, wherein the method comprises:
sending a first uniform resource identifier (URI) setting message to a digital media renderer, wherein the first URI setting message comprises a first uniform resource identifier corresponding to a first image;
sending a media playback message to the digital media renderer, so that the digital media renderer acquires, according to the first URI setting message, the first image corresponding to the first URI from a digital media server, and presents the first image according to the media playback message; and
sending an adding message to the digital media renderer, wherein the adding message comprises a URI corresponding to a second image, so that the digital media renderer acquires the second image from the digital media server according to the adding message, and presents the first image and the second image together.

10. A method for presenting multiple images, wherein the method comprises:
receiving a first uniform resource identifier (URI) setting message and a media playback message that are sent by a digital media controller, wherein the first URI setting message comprises a first URI corresponding to a first image;
acquiring, according to the first URI setting message, the first image corresponding to the first URI from a digital media server;
presenting, according to the media playback message, the first image corresponding to the first URI;
receiving an adding message sent by the digital media controller, wherein the adding message comprises a second URI corresponding to a second image; and
acquiring the second image from the digital media server according to the adding message, and presenting the first image and the second image together.

11. An apparatus for presenting multiple images, wherein the apparatus comprises:
a first sending module, configured to send a first uniform resource identifier (URI) list setting message to a digital media renderer, wherein the first URI list setting message comprises a list of multiple URIs respectively corresponding to the multiple images, so that the digital media renderer acquires, according to the first URI list setting message, the multiple images corresponding to the multiple uniform resource identifiers from a digital media server; and
a second sending module, configured to send a media playback message to the digital media renderer, so that the digital media renderer presents the multiple images together according to the media playback message.

12. The apparatus according to claim 11, wherein the apparatus further comprises:
a change message sending module, configured to send a presenting manner change message to the digital media renderer, so that the digital media renderer changes a presenting manner of the multiple images in the digital media renderer.

13. The apparatus according to claim 12, wherein the change message sending module comprises a first change message sending unit, a second change message sending unit, a third change message sending unit, or a fourth change message sending unit, wherein
the first change message sending unit is configured to send a second URI list setting message that comprises multiple URIs listed according to a sequence to the digital media renderer, so that the digital media renderer arranges and displays, according to the sequence, multiple images corresponding to the multiple URIs listed according to the sequence;
the second change message sending unit is configured to send a third URI list setting message that comprises a URI corresponding to a newly-added image to the digital media renderer, so that the digital media renderer presents the original images and the newly-added image together;
the third change message sending unit is configured to send, to the digital media renderer, a fourth URI list setting message that comprises a URI corresponding to an image that is reserved to be presented, so that the digital media renderer presents, at the same time, the image that is reserved to be presented; and
the fourth change message sending unit is configured to send a fifth URI list setting message that comprises a URI corresponding to a substituting image to the digital media renderer, so that the digital media renderer presents a non-substituted image and the substituting image together.

14. An apparatus for presenting multiple images, wherein the apparatus comprises:
a receiving module, configured to receive a first uniform resource identifier (URI) list setting message and a media playback message that are sent by a digital media controller, wherein the first URI list setting message comprises a list of multiple URIs respectively corresponding to the multiple images;
an acquiring module, configured to acquire, according to the first URI list setting message, the multiple images corresponding to the multiple uniform resource identifiers from a digital media server; and
a presenting module, configured to present together, according to the media playback message, the multiple images corresponding to the multiple URIs.

15. The apparatus according to claim 14, wherein the apparatus further comprises:
a change message receiving module, configured to receive a presenting manner change message sent by the digital media controller; and
a presenting manner changing module, configured to change a presenting manner of the multiple images in the digital media renderer according to the presenting manner change message.

16. The apparatus according to claim 15, wherein the change message receiving module comprises: a first change message receiving unit, configured to receive a second URI list setting message that is sent by the digital media controller and comprises multiple uniform resource identifiers listed according to a sequence; and the presenting manner changing module comprises: a first re-presenting unit, configured to arrange and display, according to the sequence, multiple images corresponding to the multiple uniform resource identifiers listed according to the sequence; or
the change message receiving module comprises: a second change message receiving unit, configured to receive a third URI list setting message that is sent by the digital media controller and comprises a uniform resource identifier corresponding to a newly-added image; and the presenting manner changing module comprises: a second re-presenting unit, configured to present the original images and the newly-added image at the same time according to the third URI list setting message; or
the change message receiving module comprises: a third change message receiving unit, configured to receive a fourth URI list setting message that is sent by the digital media controller and comprises a uniform resource identifier corresponding to an image that is reserved to be presented; and the presenting manner changing module comprises: a third re-presenting unit, configured to present, at the same time and according to the fourth URI list setting message, the image that is reserved to be presented; or
the change message receiving module comprises: a fourth change message receiving unit, configured to receive a fifth URI list setting message that is sent by the digital media controller and comprises a uniform resource identifier corresponding to a substituting image; and the presenting manner changing module comprises: a fourth re-presenting unit, configured to present a non-substituted image and the substituting image at the same time according to the fifth URI list setting message.

17. The apparatus according to claim 14, wherein the presenting module comprises:
a calculating unit, configured to calculate a length-width ratio of each image in the multiple images according to a list of multiple pieces of image file metadata information;
a length-width ratio determining unit, configured to determine whether each image in the multiple images is equal in length-width ratio;
an adjusting unit, configured to: if a result determined by the length-width ratio determining unit is not equal, adjust the length-width ratio of each image in the multiple images so that each image in the multiple images is equal in length-width ratio;
a zooming unit, configured to zoom, by an equal proportion, each image that is equal in length-width ratio so that each image in the multiple images is equal in size; and
an arranging and displaying unit, configured to arrange and display, according to a listing sequence of the multiple corresponding uniform resource identifiers, the multiple images that are equal in size.

18. An apparatus for presenting multiple images, wherein the apparatus comprises:
a first sending module, configured to send a first uniform resource identifier (URI) setting message to a digital media renderer, wherein the first URI setting message comprises a first URI corresponding to a first image;
a second sending module, configured to send a media playback message to the digital media renderer, so that the digital media renderer acquires, according to the first URI setting message, the first image corresponding to the first URI from a digital media server, and presents the first image according to the media playback message; and
a third sending module, configured to send an adding message to the digital media renderer, wherein the adding message comprises a second URI corresponding to a second image, so that the digital media renderer acquires, according to the adding message, the second image corresponding to the second URI from the digital media server, and presents the first image and the second image together.

19. An apparatus for presenting multiple images, wherein the apparatus comprises:
a first receiving module, configured to receive a first uniform resource identifier (URI) setting message and a media playback message that are sent by a digital media controller, wherein the first URI setting message comprises a first URI corresponding to a first image;
a first acquiring module, configured to acquire, according to the first URI setting message and the media playback message, the first image corresponding to the first URI from a digital media server;
a presenting module, configured to present the first image corresponding to the first uniform resource identifier;
a second receiving module, configured to receive an adding message sent by the digital media controller, wherein the adding message comprises a second uniform resource identifier corresponding to a second image; and
a second acquiring module, configured to acquire, according to the adding message, the second image corresponding to the second uniform resource identifier from the digital media server, wherein
the presenting module is further configured to present the first image and the second image together.

20. A mobile terminal, wherein the mobile terminal comprises a digital media source, a control module, and a display module, wherein
the digital media source is configured to transfer multiple images to the display module under control of the control module;
the control module is configured to send a first uniform resource identifier (URI) list setting message and send a media playback message to the display module, wherein the first URI list setting message comprises a list of multiple uniform resource identifiers respectively corresponding to the multiple images; and
the display module is configured to receive the first uniform resource identifier URI list setting message and the media playback message that are sent by the control module; acquire, according to the first URI list setting message, the multiple images corresponding to the multiple URIs from the digital media source; and present the multiple images together according to the media playback message.
